(19) United States
(12) Patent Application Publication
(10) Pub. No.: US 2024/0182333 A1
(43) Pub. Date: Jun. 6, 2024

(54) METHODS OF TREATING COMPOUNDS USING VISIBLE LIGHT-ENABLED ACTIVATION OF PEROXYDISULFATE

(71) Applicant: THE TEXAS A&M UNIVERSITY SYSTEM, College Station, TX (US)

(72) Inventors: Xingmao MA, College Station, TX (US); Virender K. SHARMA, College Station, TX (US)

(21) Appl. No.: 18/526,487

(22) Filed: Dec. 1, 2023

Related U.S. Application Data
(60) Provisional application No. 63/429,279, filed on Dec. 1, 2022.

(51) Int. Cl. C02F 1/72; C02F 1/30

(52) U.S. Cl. CPC C02F 1/722; C02F 1/30; C02F 2101/306; C02F 2303/04; C02F 2305/023

(57) ABSTRACT

The present disclosure provides methods for treatment utilizing reactive oxygen species generated from peroxydisulfate using a source of visible light. As described herein, the reactive oxygen species generated from peroxydisulfate can be utilized to treat compounds such as pesticides, herbicides, pharmaceuticals, and microorganisms in water such as groundwater, drinking water, or surface water.

### CROSS-REFERENCE TO RELATED APPLICATIONS

This application claims the benefit under 35 USC § 119(e) of U.S. Provisional Application Ser. No. 63/429,279, filed on Dec. 1, 2022, the entire disclosure of which is incorporated herein by reference.

### BACKGROUND AND SUMMARY OF THE INVENTION

A 40% global water deficit is projected by the year 2030 and methods to reduce water stress on environments around the world are of extreme importance. For instance, several technologies are currently available to treat wastewater for renewed use or consumption including advanced oxidation processes (AOPs) using highly reactive species generated from peroxymonosulfate (PMS).

However, current methods for water treatment are either inefficient, too expensive, or both. Furthermore, many current methods require use of multiple catalysts or excessive energy utilization in order for efficacy to occur. Thus, there exists a need for new methods of water treatment that are cost effective, more efficient, and easier to use.

Accordingly, the present disclosure provides methods for treatment utilizing reactive oxygen species generated from peroxydisulfate using a source of visible light. As described herein, the reactive oxygen species generated from peroxydisulfate can be utilized to treat compounds such as pesticides, herbicides, pharmaceuticals, and microorganisms in water such as groundwater, surface water, and drinking water.

The compositions and methods of the present disclosure provide several benefits. First, the visible light utilized in the described methods can be sunlight or another easily obtainable light source. Second, the methods can be performed without requiring a catalyst and without the need for an additional energy input. Third, the methods can be adapted to inactivating, disinfecting, and/or degrading multiple compounds such as pesticides, herbicides, pharmaceuticals, and microorganisms. Fourth, the methods are capable of utilizing several different reactive oxygen species that are generated upon contacting peroxydisulfate with a source of visible light. Finally, the use of peroxydisulfate (PDS) according to the described methods is advantageous compared to current procedures using peroxymonosulfate (PMS). For instance, based on the Planck's equation, the O—O bond in PDS could be potentially broken by irradiation with wavelength shorter than 854 nm without any chemical catalyst, which covers the entire visible light spectrum. In contrast, PMS requires irradiation with wavelength shorter than 317 nm to break the peroxide bond at the reported higher BDE. Compared to PMS, PDS is also more cost effective (e.g., $ 0.18/mol versus $ 1.36/mol). Moreover, PDS showed higher reaction stoichiometric efficiency (RSE) than PMS, as defined as the number of moles of composition degraded over the number of moles of PDS consumed. Thus, using visible light for PDS activation can provide a more environmentally friendly and more efficient technology to treat hazardous organic chemicals.

Other objects, features and advantages of the present disclosure will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this

### BRIEF DESCRIPTION OF THE DRAWINGS

FIGS. 1A-1F show degradation of (FIG. 1A) ATZ, (FIG. 1B) SMX, (FIG. 1C) TMP, (FIG. 1D) SDM, (FIG. 1E) IBP, and (FIG. 1F) CMZ by PDS in dark and under light. The fluence of visible light received by the reaction solution is shown in the secondary x-axis ([composition]₀=10.0 μM, [PDS]₀=5.0 mM, [Na₂HPO_{4]=10.0} mM, pH₀=7.0, T=25° C.).

FIG. 2 shows Pseudo-first-order rate constants of ATZ degradation by PDS Light with and without the UV filter ([ATZ]₀=10.0 μM, [PDS]₀=5.0 mM, [Na₂HPO_{4]=10.0} mM, pH₀=7.0, T=25° C.; different letters indicate significant difference (p≤0.05) between the rate constants according to one-way ANOVA followed by Tukey's test).

FIGS. 3A-3B show the effect of (FIG. 3A) phosphate buffer ([PDS]₀=5.0 mM, [Na₂HPO₄]=0 or 10.0 mM, T=25° C.) and (FIG. 3B) ATZ ([PDS]₀=5.0 mM, [Na₂HPO₄]=10.0 mM, [ATZ]₀=0 or 10.0 μM, pHo=7.0, T =25° C.) on the decay of PDS in dark and under light.

FIG. 4 shows decay of PDS and ATZ in the absence and presence of each other in dark ([PDS]₀=[ATZ]₀=5.0 mM, [Na₂HPO₄] =10.0 mM, pH₀=7.0, T =25° C.).

FIGS. 5A-5C show EPR spectra of (FIG. 5A) ^{●}OH and SO₄^{●-}, (FIG. 5B) O₂^{●-}, and (FIG. 5C) ¹O₂ of PDS Dark and PDS Light in the absence of ATZ ([PDS]₀=5.0 mM, [DMPO]=[TEMP]=50.0 mM, [Na₂HPO₄]=10.0 mM).

FIG. 6 shows potential reaction pathways for the formation of reactive species by PDS Light in the absence of ATZ.

FIG. 7 shows detection of H₂O₂ based on the UV-Vis absorbance spectra of PDS Dark and PDS Light in the absence of ATZ; absorption at ˜450 nm indicates the formation of peroxovanadate as a product of H2O2 and vanadate; a zoomed-in image is presented in the inset ([PDS]₀=5.0 mM, [NH₄VO₃]₀=10.0 mM, [Na₂HPO₄]=10.0 mM).

FIGS. 8A-8B show effects of different scavengers on the degradation of ATZ by PDS Light under (FIG. 8A) oxic and (FIG. 8B) anoxic condition ([ATZ]₀=10.0 μM, [PDS]₀=5.0 mM, [Na₂HPO₄]=10.0 mM, [scavenger]₀=0.5 M, pH₀=7.0, T=25° C.).

FIG. 9A-9B shows decay of PDS with the presence of scavengers under (a) oxic and (b) anoxic condition under light; the control group in which no scavenger was present is shown in the figure but respective symbols are fully covered by other symbols ([PDS]₀=5.0 mM, [Na₂HPO₄]=10.0 mM, [MeOH]₀=[TBA]₀=[L-his]₀=0.5 M, [SOD]₀=50 U·ml⁻¹, pH₀=7.0, T=25° C.).

FIGS. 10A-10C show EPR spectra of (FIG. 10A) ^{●}OH and SO₄^{●-}, (FIG. 10B) O₂^{●-}, and (FIG. 10C) ¹O₂ of PDS Dark and PDS Light with presence of ATZ ([PDS]₀=5.0 mM, [ATZ]₀=10 μM, [DMPO]₀=[TEMP]₀=50.0 mM, [Na₂HPO₄]=10.0 mM).

FIG. 11 shows pseudo-first-order rate constants of ATZ degradation by PDS in water and D₂O (different letters indicate significant differences between the rate constants according to one-way ANOVA followed by Tukey's test, (p≤0.05)).

FIG. 12 shows MS1 and MS2 spectra of identified degradation metabolites of ATZ in PDS Dark and PDS Light systems.

FIG. 13 shows proposed degradation pathways of ATZ by PDS Dark and PDS Light.

FIG. 14 shows potential reaction pathways for the formation of reactive species by PDS Light in presence of ATZ.

FIG. 15 shows the possible degradation pathway of ATZ by ¹O₂ in the PDS light system.

FIG. 16 shows absorption at ˜450 nm indicates the formation of peroxovanadate as a product of H₂O₂ and vanadate. The inset shows ([PDS]₀=5.0 mM, [NH₄VO₃]₀=10.0 mM, [Na₂HPO₄]=10.0 mM).

### DETAILED DESCRIPTION

Various embodiments of the invention are described herein as follows. In an illustrative aspect, a method of treating a compound with a reactive oxygen species is provided. The method comprises a) contacting peroxydisulfate with a source of visible light to generate the reactive oxygen species, and b) treating the compound with the reactive oxygen species generated from peroxydisulfate.

In an embodiment, the treating comprises inactivation of the compound. In an embodiment, the treating comprises disinfecting of the compound. In an embodiment, the treating comprises degrading the compound.

In an embodiment, the reactive oxygen species is selected from the group consisting of SO₄^{●-}, SO₃^{●-}, SO₂O₅^{●}, ^{●}OH, O₂^{●-}, ¹O₂, H₂O₂, and any combination thereof. In an embodiment, the reactive oxygen species comprises SO₄^{●-}. In an embodiment, the reactive oxygen species comprises SO₃^{●-}. In an embodiment, the reactive oxygen species comprises SO₂O₅^{●}. In an embodiment, the reactive oxygen species comprises ^{●}OH. In an embodiment, the reactive oxygen species comprises O₂^{●-}. In an embodiment, the reactive oxygen species comprises ¹O₂. In an embodiment, the reactive oxygen species comprises H₂O₂.

In an embodiment, the reactive oxygen species comprises a radical reactive oxygen species. In an embodiment, the radical reactive oxygen species is selected from the group consisting of SO₄^{●-}, ^{●}OH, O₂^{●-}, and any combination thereof. In an embodiment, the radical reactive oxygen species comprises SO₄^{●-}. In an embodiment, the radical reactive oxygen species comprises SO₃^{●-}. In an embodiment, the radical reactive oxygen species comprises S₂O₅^{●}. In an embodiment, the radical reactive oxygen species comprises ^{●}OH. In an embodiment, the radical reactive oxygen species comprises O₂^{●-}.

In an embodiment, the reactive oxygen species comprises a non-radical reactive oxygen species. In an embodiment, the non-radical reactive oxygen species comprises ¹O₂. In an embodiment, the non-radical reactive oxygen species comprises H₂O₂.

In an embodiment, the source of visible light comprises sunlight. In an embodiment, the source of visible light comprises ultraviolet light. In an embodiment, the source of visible light comprises infrared light.

In an embodiment, the compound is in a liquid. In an embodiment, the liquid is water. In an embodiment, the liquid is drinking water. In an embodiment, the liquid is groundwater. In an embodiment, the liquid is surface water.

In an embodiment, the compound is a pesticide. In an embodiment, the compound is a herbicide. In an embodiment, the compound is a pharmaceutical. In an embodiment, the compound is a microorganism.

In an embodiment, the microorganism is a pathogenic microorganism. In an embodiment, the microorganism is a bacteria. In an embodiment, the bacteria is Escherichia coli. In an embodiment, the bacteria is Salmonella spp. In an embodiment, the bacteria is Clostridioides difficile.

In an embodiment, the microorganism is Giardia duodenalis. In an embodiment, the microorganism is Cyclospora spp.

In an embodiment, the microorganism is a virus. In an embodiment, the virus is SARS-COV-2. In an embodiment, the virus is Bacteriophage f2.

In an embodiment, the compound is a pollutant. In an embodiment, the pollutant is an environmental pollutant. In an embodiment, the pollutant is a recalcitrant compound.

In an embodiment, step b) is performed in water. In an embodiment, step b) is performed in a water treatment facility.

In an embodiment, the method is performed substantially free of a catalyst. In an embodiment, the method is performed substantially free of a homo-catalyst. In an embodiment, the method is performed substantially free of a hetero-catalyst. In an embodiment, the method is performed substantially free of a dye photosensitizer. As used herein, the term “substantially free” can refer to a low number or a low concentration, such as less than 5%, less than 4%, less than 3%, less than 2%, less than 1%, less than 0.1% less than 0.01%, and the like.

In an embodiment, the method does not comprise an additional activator compound. In an embodiment, the method does not comprise an additional energy input. In an embodiment, the method is performed at an ambient temperature.

In an illustrative aspect, a method of inactivating a compound with a reactive oxygen species is provided. The method comprises a) contacting peroxydisulfate with a source of visible light to generate the reactive oxygen species, and b) inactivating the compound with the reactive oxygen species generated from peroxydisulfate. The previously described embodiments of the method of treating a compound are applicable to the method of inactivating a compound described herein.

In an illustrative aspect, a method of disinfecting a compound with a reactive oxygen species is provided. The method comprises a) contacting peroxydisulfate with a source of visible light to generate the reactive oxygen species, and b) disinfecting the compound with the reactive oxygen species generated from peroxydisulfate. The previously described embodiments of the method of treating a compound are applicable to the method of disinfecting a compound described herein.

In an illustrative aspect, a method of degrading a compound with a reactive oxygen species is provided. The method comprises a) contacting peroxydisulfate with a source of visible light to generate the reactive oxygen species, and b) degrading the compound with the reactive oxygen species generated from peroxydisulfate. The previously described embodiments of the method of treating a compound are applicable to the method of degrading a compound described herein.

The following numbered embodiments are contemplated and are non-limiting:
1. A method of treating a compound with a reactive oxygen species, the method comprising:
   a) contacting peroxydisulfate with a source of visible light to generate the reactive oxygen species, and
   b) treating the compound with the reactive oxygen species generated from peroxydisulfate.
2. The method of clause 1, any other suitable clause, or any combination of suitable clauses, wherein the treating comprises inactivation of the compound.
3. The method of clause 1, any other suitable clause, or any combination of suitable clauses, wherein the treating comprises disinfecting of the compound.
4. The method of clause 1, any other suitable clause, or any combination of suitable clauses, wherein the treating comprises degrading the compound.
5. The method of clause 1, any other suitable clause, or any combination of suitable clauses, wherein the reactive oxygen species is selected from the group consisting of SO₄^{●-}, SO₃^{●-}, S₂O₅^{●}, ^{●}OH, O₂^{●-}, ¹O₂, H₂O₂, and any combination thereof.
6. The method of clause 1, any other suitable clause, or any combination of suitable clauses, wherein the reactive oxygen species comprises SO₄^{●-}.
7. The method of clause 1, any other suitable clause, or any combination of suitable clauses, wherein the reactive oxygen species comprises SO₃^{●-}.
8. The method of clause 1, any other suitable clause, or any combination of suitable clauses, wherein the reactive oxygen species comprises S₂O₅^{●}.
9. The method of clause 1, any other suitable clause, or any combination of suitable clauses, wherein the reactive oxygen species comprises ^{●}OH.
10. The method of clause 1, any other suitable clause, or any combination of suitable clauses, wherein the reactive oxygen species comprises O₂^{●-}.
11. The method of clause 1, any other suitable clause, or any combination of suitable clauses, wherein the reactive oxygen species comprises ¹O₂.
12. The method of clause 1, any other suitable clause, or any combination of suitable clauses, wherein the reactive oxygen species comprises H₂O₂.
13. The method of clause 1, any other suitable clause, or any combination of suitable clauses, wherein the reactive oxygen species comprises a radical reactive oxygen species.
14. The method of clause 13, any other suitable clause, or any combination of suitable clauses, wherein the radical reactive oxygen species is selected from the group consisting of SO₄^{●-}, OH, O₂^{●-}, and any combination thereof.
15. The method of clause 13, any other suitable clause, or any combination of suitable clauses, wherein the radical reactive oxygen species comprises SO₄^{●-}.
16. The method of clause 13, any other suitable clause, or any combination of suitable clauses, wherein the radical reactive oxygen species comprises SO₃^{●-}. wherein the radical reactive oxygen species comprises S₂O₅^{●}.
17. The method of clause 13, any other suitable clause, or any combination of suitable clauses, The method of clause 13, any other suitable clause, or any combination of suitable clauses, wherein the radical reactive oxygen species comprises ^{●}OH.
18. The method of clause 13, any other suitable clause, or any combination of suitable clauses, wherein the radical reactive oxygen species comprises O₂^{●-}.
19. The method of clause 1, any other suitable clause, or any combination of suitable clauses, wherein the reactive oxygen species comprises a non-radical reactive oxygen species.
20 The method of clause 20, any other suitable clause, or any combination of suitable clauses, wherein the non-radical reactive oxygen species comprises ¹O₂.
21. The method of clause 20, any other suitable clause, or any combination of suitable clauses, wherein the non-radical reactive oxygen species comprises H₂O₂.
22 The method of clause 1, any other suitable clause, or any combination of suitable clauses, wherein the source of visible light comprises sunlight.
23. The method of clause 1, any other suitable clause, or any combination of suitable clauses, wherein the source of visible light comprises ultraviolet light.
24. The method of clause 1, any other suitable clause, or any combination of suitable clauses, wherein the source of visible light comprises infrared light.
25. The method of clause 1, any other suitable clause, or any combination of suitable clauses, wherein the compound is in a liquid.
26. The method of clause 26, any other suitable clause, or any combination of suitable clauses, wherein the liquid is water.
27. The method of clause 26, any other suitable clause, or any combination of suitable clauses, wherein the liquid is drinking water.
28. The method of clause 26, any other suitable clause, or any combination of suitable clauses, wherein the liquid is groundwater or surface water.
29 The method of clause 1, any other suitable clause, or any combination of suitable clauses, wherein the compound is a pesticide.
30. The method of clause 1, any other suitable clause, or any combination of suitable clauses, wherein the compound is a herbicide.
31. The method of clause 1, any other suitable clause, or any combination of suitable clauses, wherein the compound is a pharmaceutical.
32 The method of clause 1, any other suitable clause, or any combination of suitable clauses, wherein the compound is a microorganism.
33. The method of clause 33, any other suitable clause, or any combination of suitable clauses, wherein the microorganism is a pathogenic microorganism.
34. The method of clause 33, any other suitable clause, or any combination of suitable clauses, wherein the microorganism is a bacteria.
35. The method of clause 35, any other suitable clause, or any combination of suitable clauses, wherein the bacteria is Escherichia coli.
36 The method of clause 35, any other suitable clause, or any combination of suitable clauses, wherein the bacteria is Salmonella spp.
37. The method of clause 35, any other suitable clause, or any combination of suitable clauses, wherein the bacteria is Clostridioides difficile.
38. The method of clause 33, any other suitable clause, or any combination of suitable clauses, wherein the microorganism is Giardia duodenalis.
39. The method of clause 33, any other suitable clause, or any combination of suitable clauses, wherein the microorganism is Cyclospora spp.
40. The method of clause 33, any other suitable clause, or any combination of suitable clauses, wherein the microorganism is a virus.
41. The method of clause 41, any other suitable clause, or any combination of suitable clauses, wherein the virus is SARS-COV-2.
42. The method of clause 41, any other suitable clause, or any combination of suitable clauses, wherein the virus is Bacteriophage f2.
43. The method of clause 1, any other suitable clause, or any combination of suitable clauses, wherein the compound is a pollutant.
44. The method of clause 44, any other suitable clause, or any combination of suitable clauses, wherein the pollutant is an environmental pollutant.
45. The method of clause 44, any other suitable clause, or any combination of suitable clauses, wherein the pollutant is a recalcitrant compound.
46. The method of clause 1, any other suitable clause, or any combination of suitable clauses, wherein step b) is performed in water.
47 The method of clause 1, any other suitable clause, or any combination of suitable clauses, wherein step b) is performed in a water treatment facility.
48. The method of clause 1, any other suitable clause, or any combination of suitable clauses, wherein the method is performed substantially free of a catalyst.
49. The method of clause 1, any other suitable clause, or any combination of suitable clauses, wherein the method is performed substantially free of a homo-catalyst.
50. The method of clause 1, any other suitable clause, or any combination of suitable clauses, wherein the method is performed substantially free of a hetero-catalyst.
51 The method of clause 1, any other suitable clause, or any combination of suitable clauses, wherein the method is performed substantially free of a dye photosensitizer.
52. The method of clause 1, any other suitable clause, or any combination of suitable clauses, wherein the method does not comprise an additional activator compound.
53. The method of clause 1, any other suitable clause, or any combination of suitable clauses, wherein the method does not comprise an additional energy input.
54. The method of clause 1, any other suitable clause, or any combination of suitable clauses, wherein the method is performed at an ambient temperature.
55. A method of inactivating a compound with a reactive oxygen species, the method comprising:
   a) contacting peroxydisulfate with a source of visible light to generate the reactive oxygen species, and
   b) inactivating the compound with the reactive oxygen species generated from peroxydisulfate.
56. The method of clause 56, any other suitable clause, or any combination of suitable clauses, wherein the reactive oxygen species is selected from the group consisting of SO₄^{●-}, SO₃^{●-}, SO₂O₅^{●}, ^{●}OH, O₂^{●-}, ¹O₂, H₂O₂, and any combination thereof.
57. The method of clause 56, any other suitable clause, or any combination of suitable clauses, wherein the reactive oxygen species comprises SO₄^{●-}.
58. The method of clause 56, any other suitable clause, or any combination of suitable clauses, wherein the reactive oxygen species comprises SO₃^{●-}.
59. The method of clause 56, any other suitable clause, or any combination of suitable clauses, wherein the reactive oxygen species comprises SO₂O₅^{●}.
60 The method of clause 56, any other suitable clause, or any combination of suitable clauses, wherein the reactive oxygen species comprises ^{●}OH.
61. The method of clause 56, any other suitable clause, or any combination of suitable clauses, wherein the reactive oxygen species comprises O₂^{●-}.
62 The method of clause 56, any other suitable clause, or any combination of suitable clauses, wherein the reactive oxygen species comprises ¹O₂.
63. The method of clause 56, any other suitable clause, or any combination of suitable clauses, wherein the reactive oxygen species comprises H₂O₂.
64. The method of clause 56, any other suitable clause, or any combination of suitable clauses, wherein the reactive oxygen species comprises a radical reactive oxygen species.
65. The method of clause 65, any other suitable clause, or any combination of suitable clauses, wherein the radical reactive oxygen species is selected from the group consisting of SO₄^{●-}, ^{●}OH, O₂^{●-}, and any combination thereof.
66. The method of clause 65, any other suitable clause, or any combination of suitable clauses, wherein the radical reactive oxygen species comprises SO₄^{●-}.
67. The method of clause 65, any other suitable clause, or any combination of suitable clauses, wherein the radical reactive oxygen species comprises SO₃^{●-}.
68. The method of clause 65, any other suitable clause, or any combination of suitable clauses, wherein the radical reactive oxygen species comprises S₂O₅^{●}.
69. The method of clause 65, any other suitable clause, or any combination of suitable clauses, wherein the radical reactive oxygen species comprises ^{●}OH.
70. The method of clause 65, any other suitable clause, or any combination of suitable clauses, wherein the radical reactive oxygen species comprises O₂^{●-}.
71. The method of clause 56, any other suitable clause, or any combination of suitable clauses, wherein the reactive oxygen species comprises a non-radical reactive oxygen species.
72. The method of clause 72, any other suitable clause, or any combination of suitable clauses, wherein the non-radical reactive oxygen species comprises ¹O₂.
73. The method of clause 72, any other suitable clause, or any combination of suitable clauses, wherein the non-radical reactive oxygen species comprises H₂O₂.
74. The method of clause 56, any other suitable clause, or any combination of suitable clauses, wherein the source of visible light comprises sunlight.
75. The method of clause 56, any other suitable clause, or any combination of suitable clauses, wherein the source of visible light comprises ultraviolet light.
76. The method of clause 56, any other suitable clause, or any combination of suitable clauses, wherein the source of visible light comprises infrared light.
77. The method of clause 56, any other suitable clause, or any combination of suitable clauses, wherein the compound is in a liquid.
78. The method of clause 78, any other suitable clause, or any combination of suitable clauses, wherein the liquid is water.
79. The method of clause 78, any other suitable clause, or any combination of suitable clauses, wherein the liquid is drinking water.
80. The method of clause 78, any other suitable clause, or any combination of suitable clauses, wherein the liquid is groundwater or surface water.
81. The method of clause 56, any other suitable clause, or any combination of suitable clauses, wherein the compound is a pesticide.
82. The method of clause 56, any other suitable clause, or any combination of suitable clauses, wherein the compound is a herbicide.
83. The method of clause 56, any other suitable clause, or any combination of suitable clauses, wherein the compound is a pharmaceutical.
84. The method of clause 56, any other suitable clause, or any combination of suitable clauses, wherein the compound is a microorganism.
85. The method of clause 85, any other suitable clause, or any combination of suitable clauses, wherein the microorganism is a pathogenic microorganism.
86. The method of clause 85, any other suitable clause, or any combination of suitable clauses, wherein the microorganism is a bacteria.
87 The method of clause 87, any other suitable clause, or any combination of suitable clauses, wherein the bacteria is Escherichia coli.
88. The method of clause 87, any other suitable clause, or any combination of suitable clauses, wherein the bacteria is Salmonella spp.
89 The method of clause 87, any other suitable clause, or any combination of suitable clauses, wherein the bacteria is Clostridioides difficile.
90. The method of clause 85, any other suitable clause, or any combination of suitable clauses, wherein the microorganism is Giardia duodenalis.
91. The method of clause 85, any other suitable clause, or any combination of suitable clauses,
92. The method of clause 85, any other suitable clause, or any combination of suitable clauses, wherein the microorganism is a virus.
93 The method of clause 93, any other suitable clause, or any combination of suitable clauses, wherein the virus is SARS-COV-2.
94. The method of clause 93, any other suitable clause, or any combination of suitable clauses, wherein the virus is Bacteriophage f2.
95 The method of clause 56, any other suitable clause, or any combination of suitable clauses, wherein the compound is a pollutant.
96. The method of clause 96, any other suitable clause, or any combination of suitable clauses, wherein the pollutant is an environmental pollutant.
97. The method of clause 96, any other suitable clause, or any combination of suitable clauses, wherein the pollutant is a recalcitrant compound.
98. The method of clause 56, any other suitable clause, or any combination of suitable clauses, wherein step b) is performed in water.
99. The method of clause 56, any other suitable clause, or any combination of suitable clauses, wherein step b) is performed in a water treatment facility.
100. The method of clause 56, any other suitable clause, or any combination of suitable clauses, wherein the method is performed substantially free of a catalyst.
101. The method of clause 56, any other suitable clause, or any combination of suitable clauses, wherein the method is performed substantially free of a homo-catalyst.
102. The method of clause 56, any other suitable clause, or any combination of suitable clauses, wherein the method is performed substantially free of a hetero-catalyst.
103. The method of clause 56, any other suitable clause, or any combination of suitable clauses, wherein the method is performed substantially free of a dye photosensitizer.
104. The method of clause 56, any other suitable clause, or any combination of suitable clauses, wherein the method does not comprise an additional activator compound.
105. The method of clause 56, any other suitable clause, or any combination of suitable clauses, wherein the method does not comprise an additional energy input.
106. The method of clause 56, any other suitable clause, or any combination of suitable clauses, wherein the method is performed at an ambient temperature.
107. A method of disinfecting a compound with a reactive oxygen species, the method comprising:
   a) contacting peroxydisulfate with a source of visible light to generate the reactive oxygen species, and
   b) disinfecting the compound with the reactive oxygen species generated from peroxydisulfate.
108. The method of clause 108, any other suitable clause, or any combination of suitable clauses, wherein the reactive oxygen species is selected from the group consisting of SO₄^{●-}, SO₃^{●-}, SO₂O₅^{●}, ^{●}OH, O₂^{●-}, ¹O₂, H₂O₂, and any combination thereof.
109. The method of clause 108, any other suitable clause, or any combination of suitable clauses, wherein the reactive oxygen species comprises SO₄^{●-}.
110. The method of clause 108, any other suitable clause, or any combination of suitable clauses, wherein the reactive oxygen species comprises SO₃^{●-}.
111. The method of clause 108, any other suitable clause, or any combination of suitable clauses, wherein the reactive oxygen species comprises SO₂O₅^{●}.
112. The method of clause 108, any other suitable clause, or any combination of suitable clauses, wherein the reactive oxygen species comprises ^{●}OH.
113. The method of clause 108, any other suitable clause, or any combination of suitable clauses, wherein the reactive oxygen species comprises O₂^{●-}.
114. The method of clause 108, any other suitable clause, or any combination of suitable clauses, wherein the reactive oxygen species comprises ¹O₂.
115. The method of clause 108, any other suitable clause, or any combination of suitable clauses, wherein the reactive oxygen species comprises H₂O₂.
116. The method of clause 108, any other suitable clause, or any combination of suitable clauses, wherein the reactive oxygen species comprises a radical reactive oxygen species.
117. The method of clause 117, any other suitable clause, or any combination of suitable clauses, wherein the radical reactive oxygen species is selected from the group consisting of SO₄^{●-}, ^{●}OH, O₂^{●-}, and any combination thereof.
118. The method of clause 117, any other suitable clause, or any combination of suitable clauses, wherein the radical reactive oxygen species comprises SO₄^{●-}.
119. The method of clause 117, any other suitable clause, or any combination of suitable clauses, wherein the radical reactive oxygen species comprises SO₃^{●-}.
120. The method of clause 117, any other suitable clause, or any combination of suitable clauses, wherein the radical reactive oxygen species comprises SO₂O₅^{●}.
121. The method of clause 117, any other suitable clause, or any combination of suitable clauses, wherein the radical reactive oxygen species comprises ^{●}OH.
122. The method of clause 117, any other suitable clause, or any combination of suitable clauses, wherein the radical reactive oxygen species comprises O₂^{●-}.
123. The method of clause 108, any other suitable clause, or any combination of suitable clauses, wherein the reactive oxygen species comprises a non-radical reactive oxygen species.
124. The method of clause 124, any other suitable clause, or any combination of suitable clauses, wherein the non-radical reactive oxygen species comprises ¹O₂.
125. The method of clause 124, any other suitable clause, or any combination of suitable clauses, wherein the non-radical reactive oxygen species comprises H₂O₂.
126. The method of clause 108, any other suitable clause, or any combination of suitable clauses, wherein the source of visible light comprises sunlight.
127. The method of clause 108, any other suitable clause, or any combination of suitable clauses, wherein the source of visible light comprises ultraviolet light.
128. The method of clause 108, any other suitable clause, or any combination of suitable clauses, wherein the source of visible light comprises infrared light.
129. The method of clause 108, any other suitable clause, or any combination of suitable clauses, wherein the compound is in a liquid.
130. The method of clause 130, any other suitable clause, or any combination of suitable clauses, wherein the liquid is water.
131. The method of clause 130, any other suitable clause, or any combination of suitable clauses, wherein the liquid is drinking water.
132. The method of clause 130, any other suitable clause, or any combination of suitable clauses, wherein the liquid is groundwater or surface water.
133. The method of clause 108, any other suitable clause, or any combination of suitable clauses, wherein the compound is a pesticide.
134. The method of clause 108, any other suitable clause, or any combination of suitable clauses, wherein the compound is a herbicide.
135. The method of clause 108, any other suitable clause, or any combination of suitable clauses, wherein the compound is a pharmaceutical.
136. The method of clause 108, any other suitable clause, or any combination of suitable clauses, wherein the compound is a microorganism.
137. The method of clause 137, any other suitable clause, or any combination of suitable clauses, wherein the microorganism is a pathogenic microorganism.
138. The method of clause 137, any other suitable clause, or any combination of suitable clauses, wherein the microorganism is a bacteria.
139. The method of clause 139, any other suitable clause, or any combination of suitable clauses, wherein the bacteria is Escherichia coli.
140. The method of clause 139, any other suitable clause, or any combination of suitable clauses, wherein the bacteria is Salmonella spp.
141. The method of clause 139, any other suitable clause, or any combination of suitable clauses, wherein the bacteria is Clostridioides difficile.
142. The method of clause 137, any other suitable clause, or any combination of suitable clauses, wherein the microorganism is Giardia duodenalis.
143. The method of clause 137, any other suitable clause, or any combination of suitable clauses, wherein the microorganism is Cyclospora spp.
144. The method of clause 137, any other suitable clause, or any combination of suitable clauses, wherein the microorganism is a virus.
145. The method of clause 145, any other suitable clause, or any combination of suitable clauses, wherein the virus is SARS-COV-2.
146. The method of clause 145, any other suitable clause, or any combination of suitable clauses, wherein the virus is Bacteriophage f2.
147. The method of clause 108, any other suitable clause, or any combination of suitable clauses, wherein the compound is a pollutant.
148. The method of clause 148, any other suitable clause, or any combination of suitable clauses, wherein the pollutant is an environmental pollutant.
149. The method of clause 148, any other suitable clause, or any combination of suitable clauses, wherein the pollutant is a recalcitrant compound.
150. The method of clause 108, any other suitable clause, or any combination of suitable clauses, wherein step b) is performed in water.
151. The method of clause 108, any other suitable clause, or any combination of suitable clauses, wherein step b) is performed in a water treatment facility.
152. The method of clause 108, any other suitable clause, or any combination of suitable clauses, wherein the method is performed substantially free of a catalyst.
153. The method of clause 108, any other suitable clause, or any combination of suitable clauses, wherein the method is performed substantially free of a homo-catalyst.
154. The method of clause 108, any other suitable clause, or any combination of suitable clauses, wherein the method is performed substantially free of a hetero-catalyst.
155. The method of clause 108, any other suitable clause, or any combination of suitable clauses, wherein the method is performed substantially free of a dye photosensitizer.
156. The method of clause 108, any other suitable clause, or any combination of suitable clauses, wherein the method does not comprise an additional activator compound.
157. The method of clause 108, any other suitable clause, or any combination of suitable clauses, wherein the method does not comprise an additional energy input.
158. The method of clause 108, any other suitable clause, or any combination of suitable clauses, wherein the method is performed at an ambient temperature.
159. A method of degrading a compound with a reactive oxygen species, the method comprising:
   a) contacting peroxydisulfate with a source of visible light to generate the reactive oxygen species, and
   b) degrading the compound with the reactive oxygen species generated from peroxydisulfate.
160. The method of clause 108, any other suitable clause, or any combination of suitable clauses, wherein the reactive oxygen species is selected from the group consisting of SO₄^{●-}, SO₃^{●-}, SO₂O₅^{●}, ^{●}OH, O₂^{●-}, ¹O₂, H₂O₂, and any combination thereof.
161. The method of clause 160, any other suitable clause, or any combination of suitable clauses, wherein the reactive oxygen species comprises SO₄^{●-}.
162. The method of clause 160, any other suitable clause, or any combination of suitable clauses, wherein the reactive oxygen species comprises SO₃^{●-}.
163. The method of clause 160, any other suitable clause, or any combination of suitable clauses, wherein the reactive oxygen species comprises SO₂O₅^{●}.
164. The method of clause 160, any other suitable clause, or any combination of suitable clauses, wherein the reactive oxygen species comprises ^{●}OH.
165. The method of clause 160, any other suitable clause, or any combination of suitable clauses, wherein the reactive oxygen species comprises O₂^{●-}.
166. The method of clause 160, any other suitable clause, or any combination of suitable clauses, wherein the reactive oxygen species comprises ¹O₂.
167. The method of clause 160, any other suitable clause, or any combination of suitable clauses, wherein the reactive oxygen species comprises H₂O₂.
168. The method of clause 160, any other suitable clause, or any combination of suitable clauses, wherein the reactive oxygen species comprises a radical reactive oxygen species.
169. The method of clause 160, any other suitable clause, or any combination of suitable clauses, wherein the radical reactive oxygen species is selected from the group consisting of SO₄^{●-}, ^{●}OH, O₂^{●-}, and any combination thereof.
170. The method of clause 160, any other suitable clause, or any combination of suitable clauses, wherein the radical reactive oxygen species comprises SO₄^{●-}.
171. The method of clause 160, any other suitable clause, or any combination of suitable clauses, wherein the radical reactive oxygen species comprises SO₃^{●-}.
172. The method of clause 160, any other suitable clause, or any combination of suitable clauses, wherein the radical reactive oxygen species comprises SO₂O₅^{●}.
173. The method of clause 160, any other suitable clause, or any combination of suitable clauses, wherein the radical reactive oxygen species comprises ^{●}OH.
174. The method of clause 160, any other suitable clause, or any combination of suitable clauses, wherein the radical reactive oxygen species comprises O₂^{●-}.
175. The method of clause 160, any other suitable clause, or any combination of suitable clauses, wherein the reactive oxygen species comprises a non-radical reactive oxygen species.
176. The method of clause 160, any other suitable clause, or any combination of suitable clauses, wherein the non-radical reactive oxygen species comprises ¹O₂.
177. The method of clause 160, any other suitable clause, or any combination of suitable clauses, wherein the non-radical reactive oxygen species comprises H₂O₂.
178. The method of clause 160, any other suitable clause, or any combination of suitable clauses, wherein the source of visible light comprises sunlight.
179. The method of clause 160, any other suitable clause, or any combination of suitable clauses, wherein the source of visible light comprises ultraviolet light.
180. The method of clause 160, any other suitable clause, or any combination of suitable clauses, wherein the source of visible light comprises infrared light.
181. The method of clause 160, any other suitable clause, or any combination of suitable clauses, wherein the compound is in a liquid.
182. The method of clause 182, any other suitable clause, or any combination of suitable clauses, wherein the liquid is water.
183. The method of clause 182, any other suitable clause, or any combination of suitable clauses, wherein the liquid is drinking water.
184. The method of clause 182, any other suitable clause, or any combination of suitable clauses, wherein the liquid is groundwater or surface water.
185. The method of clause 160, any other suitable clause, or any combination of suitable clauses, wherein the compound is a pesticide.
186. The method of clause 160, any other suitable clause, or any combination of suitable clauses, wherein the compound is a herbicide.
187. The method of clause 160, any other suitable clause, or any combination of suitable clauses, wherein the compound is a pharmaceutical.
188. The method of clause 160, any other suitable clause, or any combination of suitable clauses, wherein the compound is a microorganism.
189. The method of clause 189, any other suitable clause, or any combination of suitable clauses, wherein the microorganism is a pathogenic microorganism.
190. The method of clause 189, any other suitable clause, or any combination of suitable clauses, wherein the microorganism is a bacteria.
191. The method of clause 191, any other suitable clause, or any combination of suitable clauses, wherein the bacteria is Escherichia coli.
192. The method of clause 191, any other suitable clause, or any combination of suitable clauses, wherein the bacteria is Salmonella spp.
193. The method of clause 191, any other suitable clause, or any combination of suitable clauses, wherein the bacteria is Clostridioides difficile.
194. The method of clause 189, any other suitable clause, or any combination of suitable clauses, wherein the microorganism is Giardia duodenalis.
195. The method of clause 189, any other suitable clause, or any combination of suitable clauses, wherein the microorganism is Cyclospora spp.
196. The method of clause 189, any other suitable clause, or any combination of suitable clauses, wherein the microorganism is a virus.
197. The method of clause 197, any other suitable clause, or any combination of suitable clauses, wherein the virus is SARS-COV-2.
198. The method of clause 197, any other suitable clause, or any combination of suitable clauses, wherein the virus is Bacteriophage f2.
199. The method of clause 160, any other suitable clause, or any combination of suitable clauses, wherein the compound is a pollutant.
200. The method of clause 200, any other suitable clause, or any combination of suitable clauses, wherein the pollutant is an environmental pollutant.
201. The method of clause 200, any other suitable clause, or any combination of suitable clauses, wherein the pollutant is a recalcitrant compound.
202. The method of clause 160, any other suitable clause, or any combination of suitable clauses, wherein step b) is performed in water.
203. The method of clause 160, any other suitable clause, or any combination of suitable clauses, wherein step b) is performed in a water treatment facility.
204. The method of clause 160, any other suitable clause, or any combination of suitable clauses, wherein the method is performed substantially free of a catalyst.
205. The method of clause 160, any other suitable clause, or any combination of suitable clauses, wherein the method is performed substantially free of a homo-catalyst.
206. The method of clause 160, any other suitable clause, or any combination of suitable clauses, wherein the method is performed substantially free of a hetero-catalyst.
207. The method of clause 160, any other suitable clause, or any combination of suitable clauses, wherein the method is performed substantially free of a dye photosensitizer.
208. The method of clause 160, any other suitable clause, or any combination of suitable clauses, wherein the method does not comprise an additional activator compound.
209. The method of clause 160, any other suitable clause, or any combination of suitable clauses, wherein the method does not comprise an additional energy input.
210. The method of clause 160, any other suitable clause, or any combination of suitable clauses, wherein the method is performed at an ambient temperature.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

### EXAMPLE 1

### Experimental Methods and Materials

### Chemicals and Materials

Potassium peroxydisulfate (PDS, ≥99.0%) and tert-butanol (TBA) anhydrous (≥99.5%) were obtained from Sigma-Aldrich (St. Louis, USA). Atrazine (ATZ, ≥97.0%), sulfamethoxazole (SMX, ≥98.0%), trimethoprim (TMP, ≥98.0%), sulfadimethoxine (SDM, ≥98.0%), and carbamazepine (CMZ, ≥97.0%) were obtained from TCI America (Portland, USA). Sodium phosphate dibasic anhydrous (≥98.0%), sodium thiosulfate (99.0%), sodium hydroxide (≥97.0%), sulfuric acid (98.0%), 5,5-dimethyl-1-pyrroline N-oxide (DMPO, ≥98.0%) and superoxide dismutase (SOD, 3500 U/mg) were obtained from Thermo Fisher Scientific (Waltham, USA). Ibuprofen (IBP, 99%), 2,2,6,6-tetramethyl-4-piperidine (TEMP, 99%), and ammonium metavanadate (99.5%) were obtained from ACROS Organics (Waltham, USA). L-histidine (L-his, ≥98.0%) and deuterium oxide (D20, 99.8%) were obtained from Alfa Aesar (Haverhill, USA). Methanol (MeOH, reagent grade) was obtained from VWR Chemicals (Radnor, USA). Waters Oasis HLB cartridges (WAT106202, 6 cc/200 mg) were obtained from Waters (Milford, USA). All chemicals were used as received. Thin wall quartz sample tubes (4 mm and 2 mm) were obtained from Wilmad Labglass (Vineland, USA). A simulated sunlight lamp (GLBULBM1000 metal halide bulb, 1000 W, 92,000 lm) was obtained from iPower and used as the light source. A UV filter film was obtained from Edmund Optics (Barrington, USA).

### Instrument Settings of High-Performance Liquid Chromatography (HPLC)

All HPLC analysis was performed using a Dionex UltiMate 3000 high-performance liquid chromatograph (HPLC) (Sunnyvale, USA) with a Restek C18 column (4.6×250 mm, 5 μm). The mobile phase was composed of methanol and water (60/40, v/v) at a flow rate of 1.0 mL/min. The column temperature was set at 30° C.

### Instrument Settings of Electron Paramagnetic Resonance (EPR)

EPR spectrometry was performed using a Bruker Elexsys E500 EPR instrument with a standard resonator and CoolEdge cryo system (Billerica, USA). The instrument settings are: 20.0 mW microwave power, 9.8 GHz microwave frequency, 100 kHz modulation frequency, 1.00 G modulation amplitude, 3515 G center field, 150 G sweep width, and 40.0 s sweep time.

### Experimental Procedures for EPR

Approximately 50.0 mM of 5,5-dimethyl-1-pyrroline N-oxide (DMPO) was used as the spin trapping agent for ^{●}OH, SO₄ ^{●-}, and O₂ ^{●-}, while 50.0 mM of 2,2,6,6-tetramethyl-4-piperidine (TEMP) was used to probe ¹O₂. The EPR measurements for ^{●}OH and SO₄ ^{●-} were carried out in 1:1 mixture of 10.0 mM phosphate buffer and acetonitrile, and the measurement for O₂^{●-} was performed in pure methanol (MeOH) to quench ^{●}OH and SO₄^{●-}. The reaction solution was injected into a 2 mm quartz EPR tube using a syringe needle, which was then placed into a 4 mm quartz EPR tube. The EPR tubes containing the reaction solution were irradiated under the simulated sunlight lamp for 1 min and then measured by EPR.

### Procedures for Solid-Phase-Extraction (SPE)

The Waters Oasis HLB cartridges (WAT106202, 6 cc/200 mg) cartridges were sequentially pre-conditioned with 5.0 ml of methanol and 5.0 ml of ultrapure water, loaded with 50.0 ml of samples, and dried with purified N₂ gas for 30 minutes. The final extracted products were eluted with 2.0 ml of methanol.

### EXAMPLE 2

### Activation of PDS in Conditions Substantially Free of Catalyst

Various reactions were carried out in 40 mL glass tubes with constant stirring at 300 rpm at 25±0.5° C. The temperature of solutions was monitored using a thermometer throughout the experiments. The initial concentration of atrazine (ATZ) was 10.0 uM, and the initial concentration of PDS was 5.0 mM. The irradiation fluxes emitted from the lamp and received by the solutions were measured with a LS125 UV light meter (Linshang Technology, Shenzhen, China) and a Solar Light PMA2100 radiometer (Solar Light Company, Philadelphia,

USA) 10 cm away from the lamp. The tubes in the dark treatments were covered with aluminum foil. To further confirm the PDS activation by visible light, experiments were also conducted with a UV filter film covering the simulated sunlight lamp to eliminate the effect of UV light. 1.0 mL of sample was withdrawn from each tube at different elapsed times (t=0, 1, 2, 3, 4, 5, 10, 20, 30, 60, 90, 120, and 240 min) and immediately quenched by 20 μL of 5.0 M sodium thiosulfate. The concentrations of all compositions in collected samples were measured with a Dionex UltiMate 3000 high-performance liquid chromatograph (HPLC) (Sunnyvale, USA). The settings of HPLC are provided in Example 1. The change in the concentration of PDS under different conditions was determined spectrophotometrically via an oxidation decolorization method and a modified iodometric titration method, respectively. The initial and final pH in each tube were measured with an Accumet AE150 pH meter (Westford, USA).

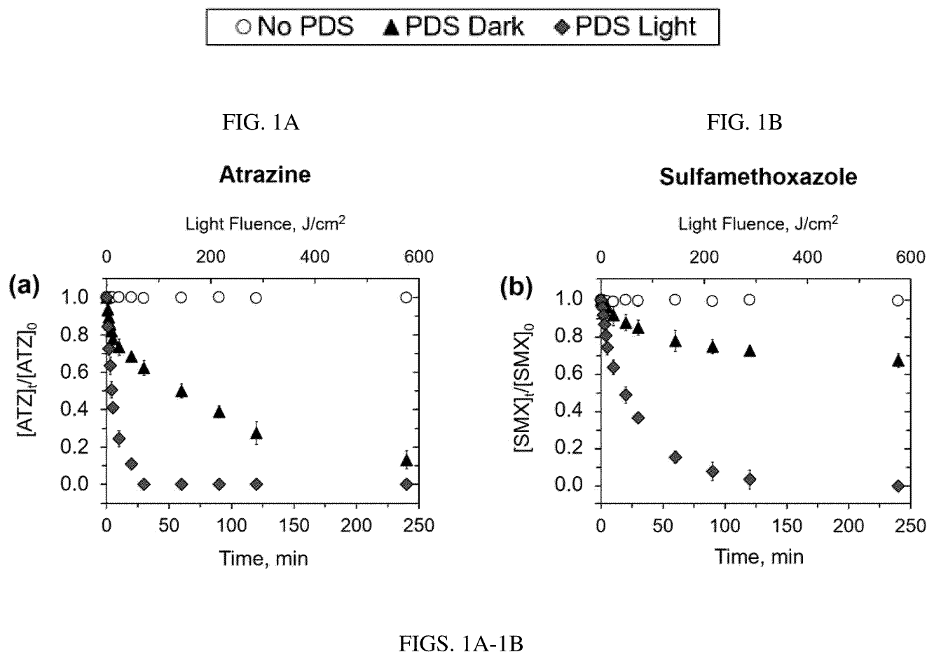

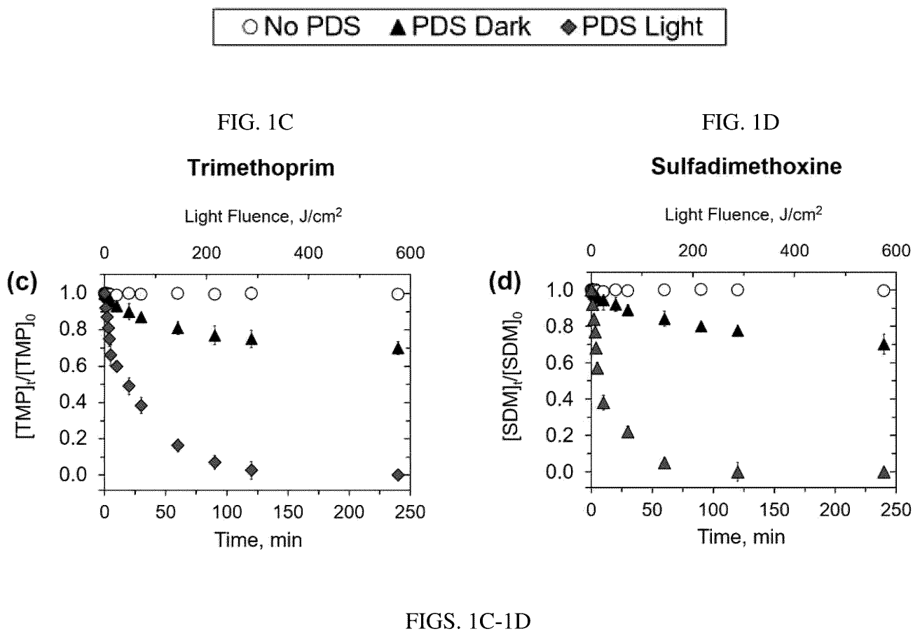

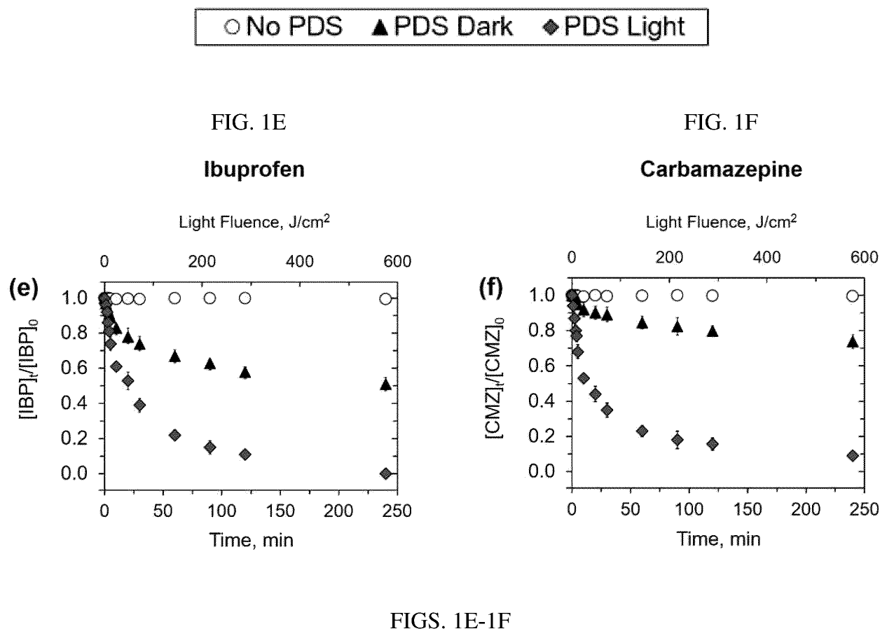

A simulated sunlight lamp was used as the light source in the instant example. The light fluxes that reaction solutions received in glass vials contained 39.8±0.5×10⁻³ W/cm² of visible light in the wavelength (λ) range of 400-700 nm. The fluxes in the UV ranges contained 8.1±0.2×10⁻⁶ W/cm² of UV-A (λ=315-400 nm) and 2.5±0.4×10⁻⁶ W/cm² of UV-B (λ=280-315 nm), respectively. The UV-C flux (λ=230-280 nm) was negligible. Based on the flux measurement, UV light only accounted for <0.03% of the total light flux, and thus the light source utilized herein represents almost exclusively the visible light. The chemistry of PDS with visible light irradiation (PDS Light) and without (PDS Dark) was explored using six common herbicides and pharmaceuticals, namely atrazine (ATZ), sulfamethoxazole (SMX), trimethoprim (TMP), sulfadimethoxine (SDM), ibuprofen (IBP), and carbamazepine (CMZ) (FIGS. 1A-1F). Interestingly, the degradation efficiencies of all six compositions by PDS were significantly improved by visible light irradiation. Using ATZ as an example, complete degradation of ATZ was achieved by PDS Light in 30 min (k_{obs}=11±3.0×10⁻² min⁻¹), however, only 37% of ATZ was degraded by PDS Dark within 30 min (k_{obs}=0.72±0.09×10⁻² min⁻¹), (FIG. 1A). To further confirm that PDS was activated by visible light, the degradation experiments of ATZ by PDS were repeated with a UV filter film placed between the sunlight lamp and glass vials to block the UV light, which completely blocked UV-B and UV-C, and only allowed 2.0±0.2×10⁻⁶ W/cm² of UV-A (Table 1).

TABLE 1
Light fluxes received by the reaction
solutions with and without UV filter.

| | Wavelength | Flux (W/cm²) | |
|---|---|---|---|
| | (nm) | Without UV filter | With UV filter |
| Visible | 400-700 | 39.8 +/− 0.5 × 10⁻³ | 39.6 +/− 0.3 × 10⁻³ |
| UV-A | 315-400 | 8.1 +/− 0.2 × 10⁻⁶ | 2.0 +/− 0.2 × 10⁻⁶ |
| UV-B | 380-315 | 2.5 +/− 0.4 × 10⁻⁶ | |
| UV-C | 230-280 | 0 | 0 |

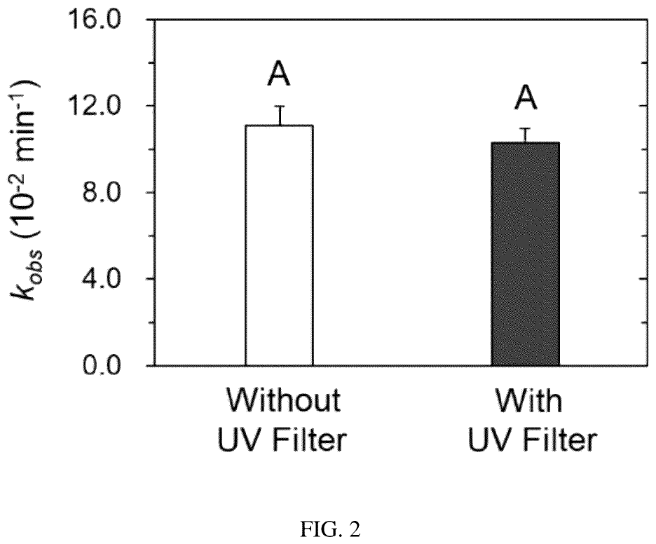

The obtained pseudo-first-order rate constants of ATZ degradation by PDS were not statistically different from the one obtained without a UV filter (FIG. 2). The results demonstrated that PDS activation was due to visible light, consistent with the postulation that the energy from visible light is sufficient to break the O—O bond in PDS.

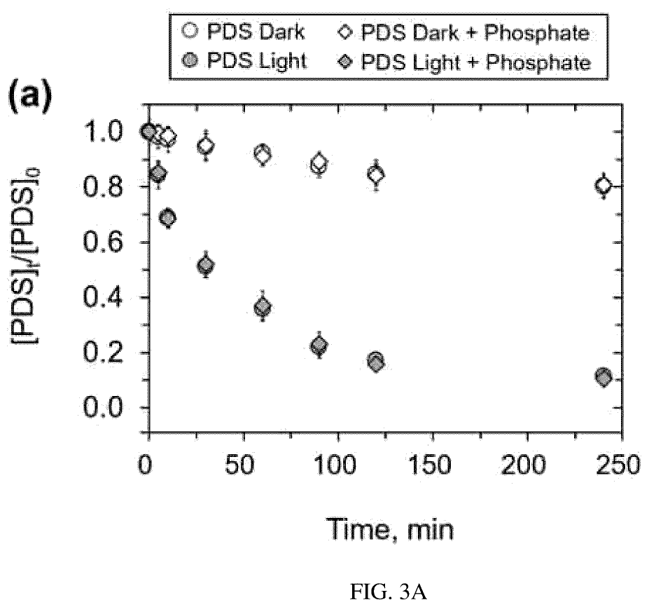

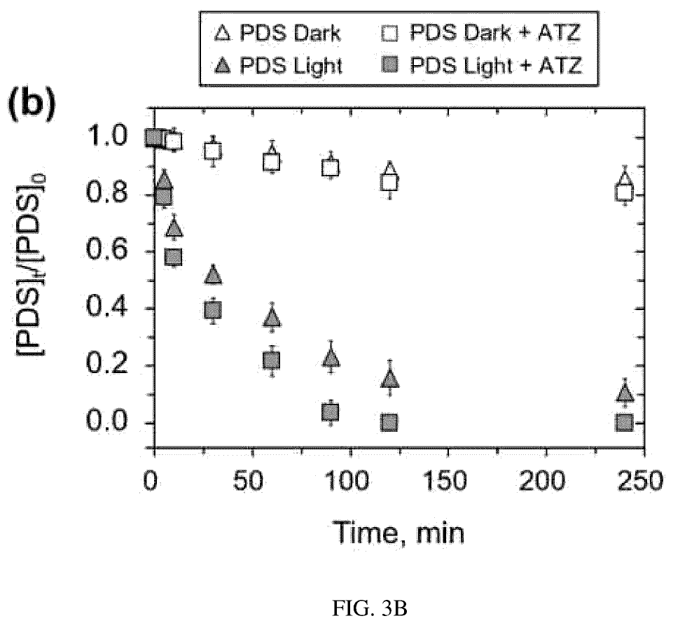

In order to verify whether PDS was directly activated by visible light, the impacts of solution constituents were examined. Because 10 mM phosphate buffer was added to control the initial pH to 7.0 to take into account of the typical pH of natural waters, the impact of phosphate buffer on the decay of PDS was investigated. Phosphate displayed negligible impact on PDS decay both in dark and under visible light (FIG. 3A). Approximately 20% and 90% of PDS decayed within 240 min in dark and under visible light, respectively, regardless of the phosphate.

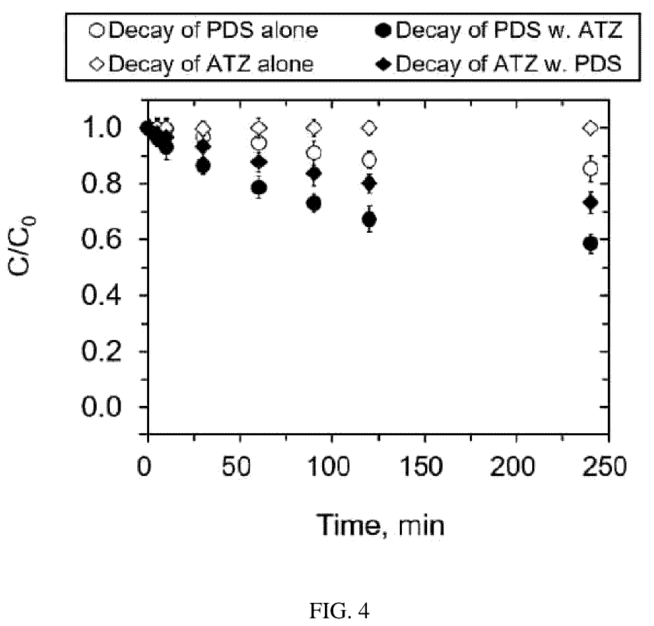

Next, the effect of ATZ was also determined. According to FIG. 3B, the presence of ATZ showed negligible effect on the decay of PDS in dark because the initial concentration of ATZ was only 0.2% of the initial concentration of PDS. The comparable rate constants of PDS decay in dark with and without ATZ supported the negligible role of ATZ in PDS decay in the experimental setup when [ATZ]₀/[PDS]₀ ratio was low. However, the notable degradation of ATZ by PDS in dark suggests that direct ATZ and PDS redox reaction could occur. To confirm this hypothesis, a separate experiment with the initial concentrations of PDS and ATZ both controlled at 5.0 mM in dark was performed. The decay of PDS and ATZ in dark were both enhanced in the presence of each other, indicating direct oxidation of ATZ by PDS (FIG. 4). The relative concentration differences of ATZ and PDS demonstrates the notable degradation of ATZ by PDS in dark (FIGS. 1A-1F) but minimal effect of ATZ on PDS decay (FIG. 3B), even though direct reaction between ATZ and PDS took place in both experiments as discussed above.

The results showed unambiguously that PDS can be directly activated by visible light without the assistance of catalysts. To gain further understanding on the different behaviors of PDS in the presence and absence of ATZ, the underlying chemistry of PDS under visible light in two different systems were examined separately. The first system is relatively “clean”, which only contains PDS, and the second system contains ATZ in addition of PDS.

### EXAMPLE 3

### Analysis via Electron Paramagnetic Resonance (PER) Spectroscopy

EPR was used to probe possible reactive species in the reaction systems. The measurement was performed using a Bruker Elexsys E500 EPR equipped with both a standard resonator and a CoolEdge cryo system (Billerica, USA). The instrument settings and procedures for the EPR measurement are presented in Example 1.

The EPR measurement was repeated with D₂O as the solvent for phosphate buffer with the same experimental setup to investigate the role of ¹O₂. In the PDS light system with and without ATZ, the EPR measurements for O₂^{●-} and ¹O₂ were also conducted under anoxic condition after 10 min of N₂ purging. The dissolved oxygen (DO) after N₂ purging was 0.12±0.02 mg/L, measured by an Orion Star A123 Dissolved Oxygen Meter, which falls in the DO range of anoxic condition (0-0.2 mg/L).

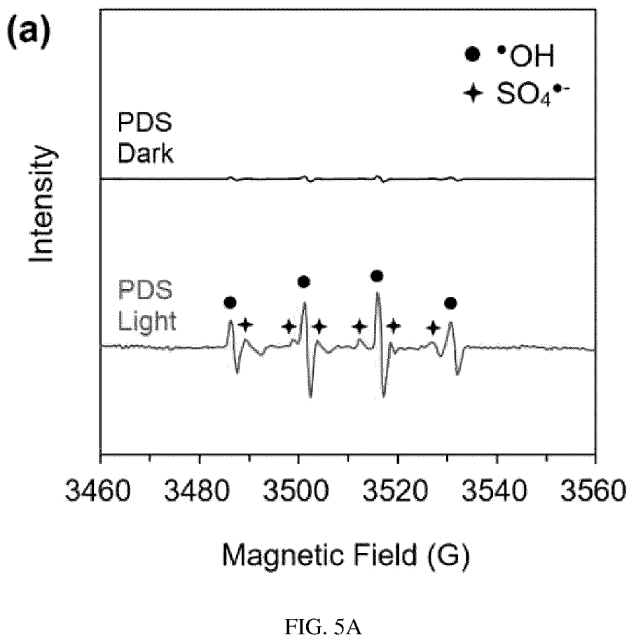

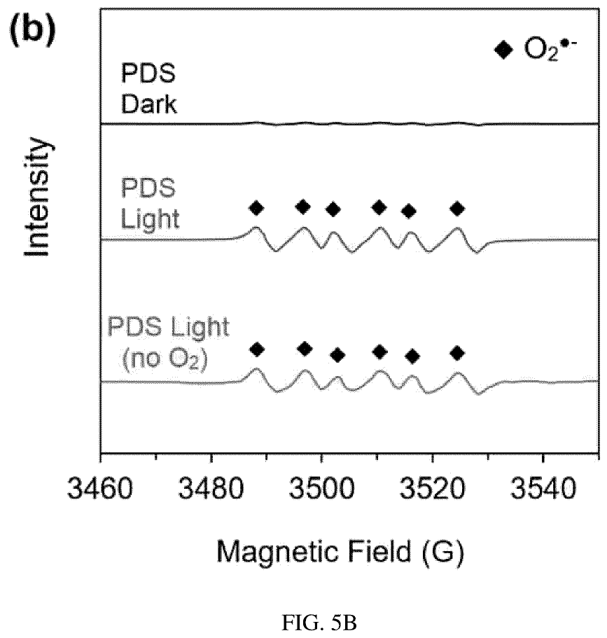

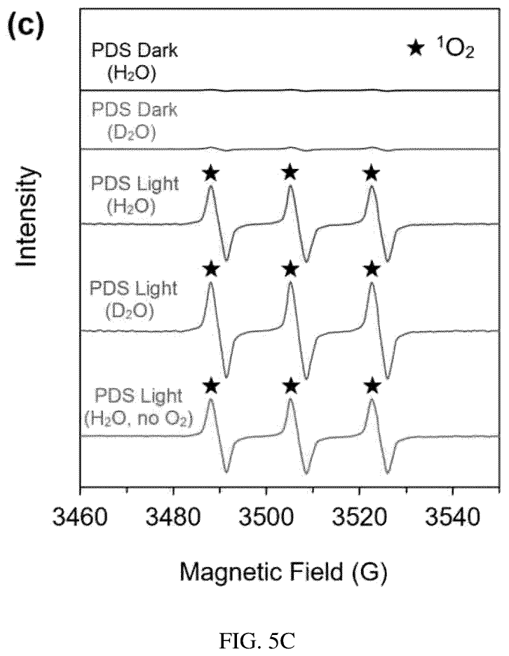

Four reactive species that are commonly present in persulfate-based systems were probed in order to reveal the undergoing reactions of PDS Light, namely SO₄^{●-}, ^{●}OH, superoxide radical (O₂^{●-}), and singlet oxygen (¹O₂). EPR spectroscopy was employed to directly detect the reactive species, with 5,5-dimethyl-1-pyrrolineN-oxide (DMPO) as the spin trapping agent for ^{●}OH, SO₄^{●-} and O₂^{●-}, and 2,2,6,6-tetramethyl-4-piperidine (TEMP) for ¹O₂ (FIGS. 5A-5C). The EPR detection for O₂^{●-} was performed in pure methanol to quench ^{●}OH and SO₄^{●-}. Clear signals of DMPO—OH^{●}, DMPO—SO₄^{●-}, and DMPO-O₂^{●-} adducts in PDS Light confirmed the formation of ^{●}OH, SO₄^{●-}, and O₂^{●-}, while the corresponding signals in PDS Dark were negligible (FIGS. 5A and 5B). The characteristic 1:1:1 peak for 2,2,6,6-tetramethyl-1-piperidinyloxyl (TEMPO), the TEMP-¹O₂ adduct, was also observed for PDS Light in water (FIG. 5C). Although the signal of TEMPO was observed, it could originate either from direct oxidation of TEMP by ¹O₂ or one-electron abstraction from TEMP as a heterocyclic amine. Consequently, EPR signal alone still cannot conclusively confirm the role of ¹O₂. The solvent-dependent lifetime of ¹O₂ is a crucial but often overlooked characteristic. ¹O₂ is quenched more slowly by deuterium oxide (k(D₂O)=1.5×10⁴s⁻¹) than by water (k(H₂O)=2.5×10⁵ s⁻¹). To take advantage of that, EPR detections were also conducted with D₂O as the solvent. The peak intensity of TEMPO for PDS Light in D₂O was nearly 1.5 times higher than that in water, confirming the formation of TEMPO via direct oxidation by ¹O₂ (FIG. 5C). Because the dissolved oxygen (O₂) could be an important precursor for O₂^{●-} and ¹O₂, EPR detections for O₂^{●-} and ¹O₂ were also performed under anoxic conditions to examine the role of O2 in PDS Light. Interestingly, the absence of O2 had little influence on the signal intensities of DMPO-O₂^{●-} and TEMPO in PDS Light, indicating that O2 was not involved in the generation of O2º- and ¹O₂.

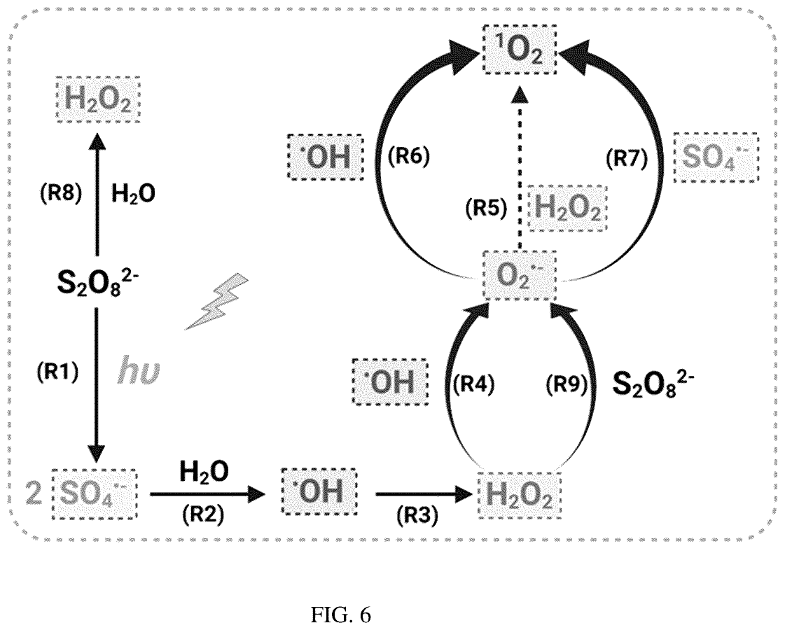

Based on the formation of reactive species in both oxic and anoxic conditions, the potential reactions involved in PDS Light clean system are presented in FIG. 6. The photolysis of PDS by light can generate two SO₄^{●-} (R1). Based on the rate constant of PDS decay in dark and under light, the rate constant for R1 was estimated at around 8.8±1.1×10⁻³ min⁻¹ in this example. The SO₄^{●-} can transform to ^{●}OH by snatching an electron from water molecule (R2). Importantly, even though the dominant species in phosphate buffer at pH 7.0 can quench SO₄^{●-} (k(SO₄^{●-}/H₂PO₄_{^{−}})<7.0×10⁴ M⁻¹·s⁻¹, k(SO₄^{●-}/HPO₄²⁻)=1.2×10⁶ M⁻¹·s⁻¹), a portion of SO₄^{●-} can still undergo R2 to produce *OH based on competitive kinetics. Subsequently, a series of reactions may take place to produce O₂^{●-}, a key precursor for ¹O₂ (R3-R10).

$${S}_{2} {{O}_{8}}^{2 -} {⟶}^{hv} {SO}_{4}^{-} + {SO}_{4}^{-} \qquad ( R1 )$$

$${SO}_{4}^{-} + {H}_{2} O {⟶}^{} OH + {SO}_{4}^{2 -} + {H}^{+} {k}_{2} = 6.6 \times 1 {0}^{2} {s}^{- 1} \qquad ( R2 )$$

$${}^{} OH + {}^{} OH ⟶ {H}_{2} {O}_{2} {k}_{3} = 5. - 6.2 \times 1 {0}^{9} {M}^{- 1} \cdot {s}^{- 1} \qquad ( R3 )$$

$${}^{} OH + {H}_{2} {O}_{2} ⟶ {O}_{2}^{-} + {H}^{+} + {H}_{2} O {k}_{4} = 2.9 - 3.8 \times 1 {0}^{7} {M}^{- 1} \cdot {s}^{- 1} \qquad ( R4 )$$

$${O}_{2}^{-} + {H}_{2} {O}_{2} {⟶}^{1} {O}_{2} + {}^{} OH + {OH}^{-} {k}_{5} = 2.3 {M}^{- 1} \cdot {s}^{- 1} \qquad ( R5 )$$

$${O}_{2}^{-} + {}^{} OH {⟶}^{1} {O}_{2} + {OH}^{-} {k}_{6} = 0.9 - 1. \times 1 {0}^{10} {M}^{- 1} \cdot {s}^{- 1} \qquad ( R6 )$$

$${SO}_{4}^{-} + {O}_{2}^{-} ⟶ {SO}_{4}^{2 -} + {O}_{2} {k}_{7} = 3.5 \times 1 {0}^{9} {M}^{- 1} \cdot {s}^{- 1} \qquad ( R7 )$$

$${S}_{2} {O}_{8}^{2 -} + 2 {H}_{2} O ⟶ 2 {SO}_{4}^{2 -} + {H}_{2} {O}_{2} + 2 {H}^{+} {k}_{8} = 1.2 \times 1 {0}^{- 5} {s}^{- 1} \qquad ( R8 )$$

$$( R9 )$$

$${S}_{2} {O}_{8}^{2 -} + 2 {H}_{2} {O}_{2} ⟶ 2 {O}_{2}^{-} + 2 {SO}_{4}^{2 -} + 4 {H}^{+} {k}_{9} = 1.2 \times 1 {0}^{7} {M}^{- 1} \cdot {s}^{- 1}$$

$${O}_{2}^{-} + {H}^{+} ⇌ {HO}_{2}^{} \qquad ( R10a )$$

$$( R10b )$$

$${HO}_{2}^{-} + {O}_{2}^{-} + {H}_{2} O {⟶}^{1} {O}_{2} + {H}_{2} {O}_{2} + {OH}^{-} {k}_{10} = 9.7 \times 1 {0}^{7} {M}^{- 1} \cdot {s}^{- 1}$$

Based on these reactions, H₂O₂ is a key intermediate in generating O₂^{●-} and ¹O₂.

Specifically, the formation of H₂O₂ via the recombination of ^{●}OH can readily occur as a near-diffusion-controlled reaction with a low activation energy of 7.65 kJ·mol⁻¹ (R3). The direct overlap between the (pᵤ)¹ orbitals of two ^{●}OH results in possible formation of H₂O₂. The produced H₂O₂ can react with ^{●}OH to produce O₂^{●-}(R4). Then ^{●}OH can react with O₂^{●-} to generate ¹O₂ (R5). The calculated changes in the Gibb's free energy (ΔG°′) for R4 and R5 are −83.0 and −14.5 kJ·mol⁻¹ respectively, based on ΔE°′ (ΔE°′(^{●}OH/H₂O)=+1.8 V; ΔE°′(O₂^{●-}/H₂O₂=+0.94 V; ΔE°′ (H₂O₂/^{●}OH,H₂O)=+0.8 V; ΔE°′(¹O₂/O₂^{●-}=+0.65 V)), indicating thermodynamic feasibility of the reactions. Despite its relatively low rate constant, R4 may be accelerated by external energy sources (i.e., visible light). It was reported that the reaction between O₂^{●-} and H₂O₂ (R5) requires direct overlap between the empty σ*ᵤ orbital of H₂O₂ and the filled or half-filled π_{g} orbital of O₂^{●-}, which is hindered by the filled π*_{g} orbital of H₂O₂. Hence, R5 might not be a major reaction contributing to the production of ¹O₂.

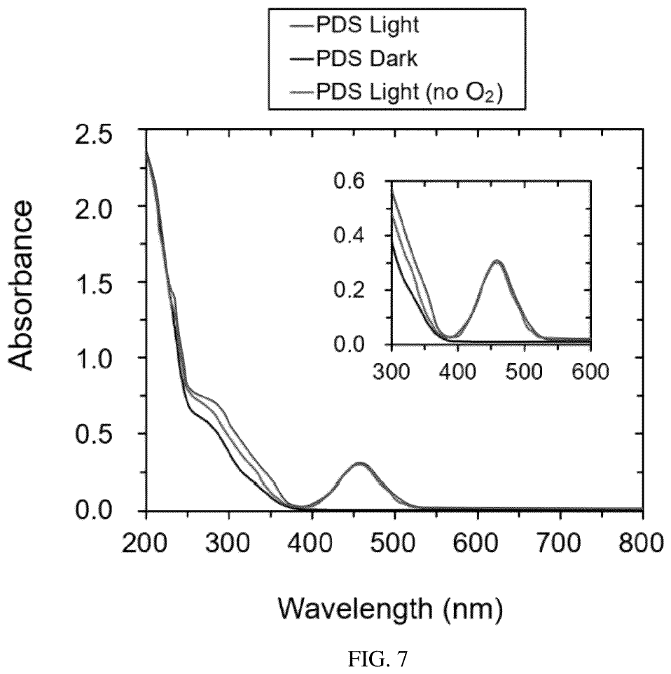

Alternatively, ^{●}OH can directly oxidize O₂^{●-} to produce ¹O₂ (R6), and formation of both singlet states of O₂ (^{1Σ}_{g}⁺O₂ and ¹Δ_{g}O₂) were proven to be thermodynamically favorable. In addition, direct overlap between the π*_{g} orbital in O₂^{●-} and the pᵤ orbital in ^{●}OH is also possible to produce ¹Δ_{g}O₂. Similarly, SO₄^{●-} can also directly oxidize O₂^{●-} to produce O₂ (R7). However, whether the produced O₂ is predominantly in the singlet or triplet state is unclear. It has also been proposed that PDS can be hydrolyzed to generate H₂O₂ (R8). Given the relatively low redox potential of H₂O₂ (1.78 V) compared to PDS (2.08 V), H₂O₂ could reduce PDS to generate O₂^{●-} (R9). Furthermore, the formation of ¹O₂ by spontaneous disproportionation of O₂^{●-} has been examined (R10a-b). Quantitative determination in literature revealed that less than 10% of the O₂ produced was in singlet state, suggesting that this might be an inefficient pathway for ¹O₂ evolution. In order to confirm the role of H₂O₂ in the PDS system, the presence of H₂O₂ in PDS Dark and PDS Light was determined following a spectrophotometric method developed based on the formation of red-orange peroxovanadate cation from the reaction between H₂O₂ and vanadate under acidic medium. No color change was observed for PDS Dark (FIG. 7). By contrast, a red-orange color was observed when the PDS Light sample was added to the light-yellow vanadate solution, with a main absorption band at 453 nm, providing strong evidence for the formation of H₂O₂ and the proposed reaction R3.

### EXAMPLE 4

### Quenching of Reactive Species

In order to identify the main reactive species involved in the degradation of ATZ by PDS under light and in dark, four quenchers were added in the beginning of the reactions to scavenge possible reactive species. The concentration of MeOH, tert-butanol (TBA), and L-histidine (L-his) was 0.5 M, and the concentration of superoxide dismutase (SOD) was 50 U·ml⁻¹. To analyze the impact of oxygen, purified N₂ gas was used to purge the system for 10 min before the quenching experiments. All tubes were capped and then sealed with parafilm to maintain an anoxic environment throughout the reaction. The ATZ concentrations in the samples taken at various time points (t=0, 5, 10, 30, 60, 120, and 240 min) were measured using HPLC. The degradation of ATZ was also repeated with D2O as the solvent for phosphate buffer with the same experimental setups.

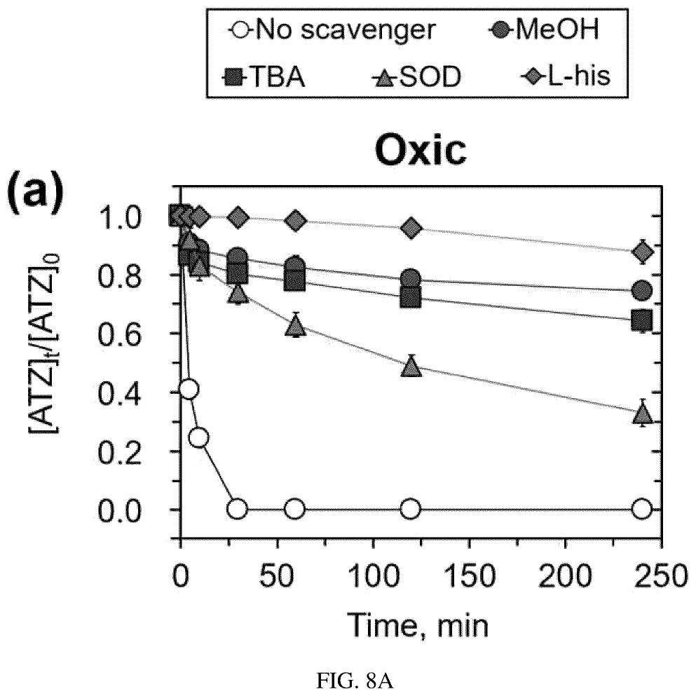

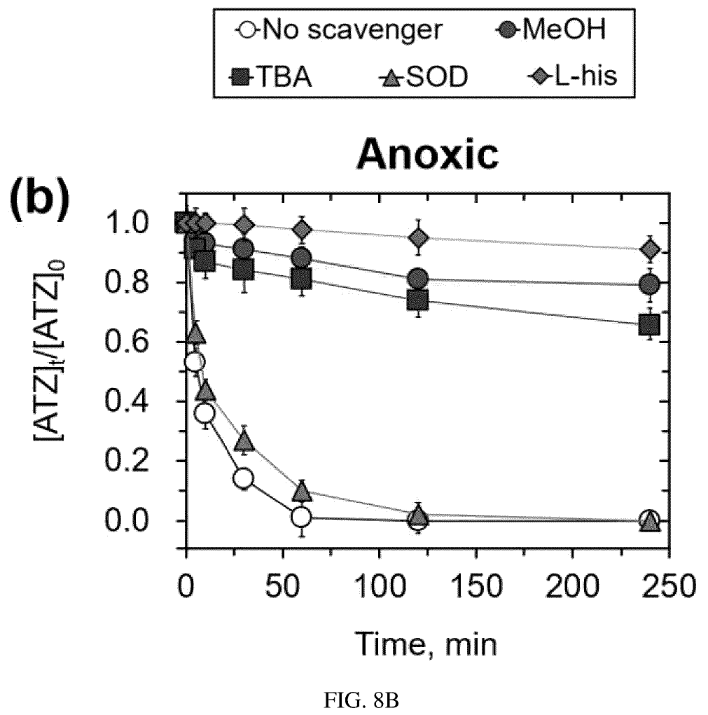

With the presence of ATZ, the mechanisms for the generation of reactive species are drastically different. First of all, ATZ has been reported to react rapidly with SO₄^{●-} (k(SO₄^{●-}/ATZ)=2.6−4.2×10⁹ M⁻¹·s⁻¹), which could significantly inhibit R2 based on competitive kinetics. Consequently, the subsequent R3-R7 are very unlikely to occur, and it is reasonable to assume that SO₄^{●-} might be the dominant reactive species that contributed to the degradation of ATZ in PDS Light. To confirm this, four scavengers were introduced to selectively quench reactive species to probe their roles (FIG. 8A). Methanol (MeOH) was used to quench both SO₄^{●-} (k=1.0×10⁷ M⁻¹·s⁻¹) and ^{●}OH (k=9.7×10⁸ M⁻¹·s⁻¹). Tert-butyl alcohol (TBA), which has a higher rate constant with OH^{●}(k=4.8×10⁸ M⁻¹·s⁻¹) than with SO₄^{●-} (k=8.4×10⁵ M⁻¹·s⁻¹), was used to specifically quench ^{●}OH. Superoxide dismutase (SOD) as an enzyme that catalyzes the disproportionation of O₂^{●-} was added to selectively quench O₂^{●-} (k=2.8×10⁹ M⁻¹·s⁻¹), and L-histidine (L-his) was used to quench ¹O₂ (k=9.0×10⁷ M⁻¹·s⁻¹). The concentration of each quencher was 100 times higher than that of PDS to ensure efficient quenching of reactive species. It should be noted that p-benzoquinone as a common quencher for O₂^{●-} was not used due to its potential to activate PDS via electron transfer. Furthermore, an often overlooked fact is that the second-order rate constants between L-his and SO₄^{●-} (k=2.5×10⁹ M⁻¹·s⁻¹) and ^{●}OH (k=4.8×10⁹ M⁻¹·s⁻¹) are more than one order of magnitude higher than that between L-his and 1O₂. Other scavengers for ¹O₂ such as N₃_{^{−}} and FFA also suffer from the same limitations. Thus, quenching experiments can only provide preliminary information on the involvement of ¹O₂. Overall, the ATZ degradation by PDS Light was significantly hindered by all four scavengers, with L-his almost completely inhibited the degradation.

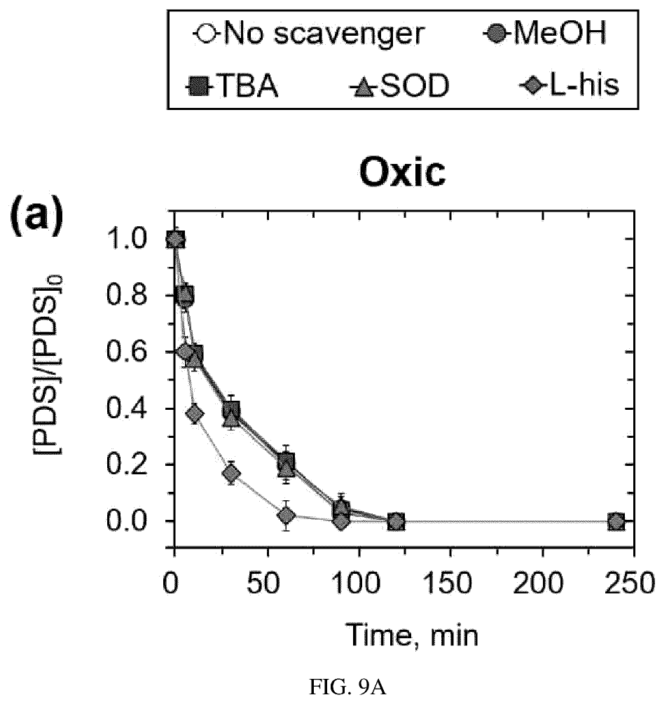

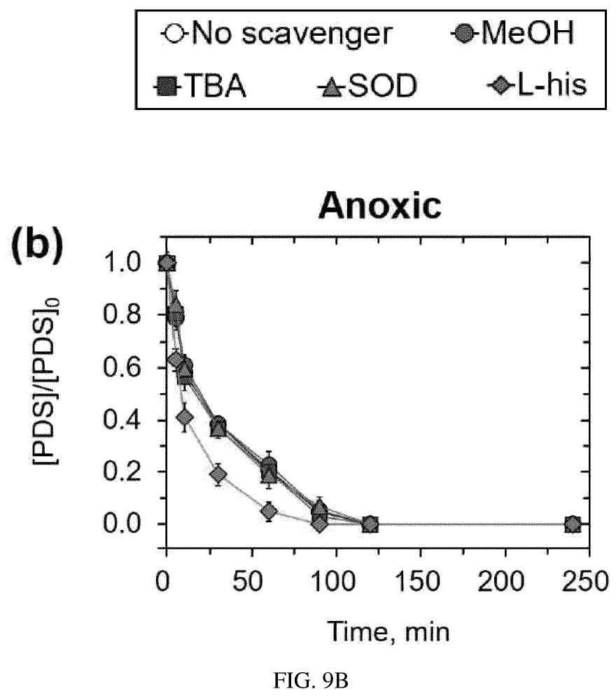

The inhibitory effect of MeOH was stronger than that of TBA, consistent with the belief that SO₄^{●-} might be the main radical species. Surprisingly, the presence of SOD also reduced the degradation efficiency dramatically, suggesting the involvement of O₂^{●-} likely through different reactions from R4. The quenching experiments were also conducted under anoxic condition to investigate the role of O₂ in the generation of reactive species in the presence of ATZ (FIG. 8B). Without scavengers, the degradation efficiency of ATZ was markedly retarded under anoxic condition, according to the corresponding pseudo-first-order rate constant (k_{obs(anoxic)}=7.3±0.9×10⁻² min⁻¹ vs. k_{obs(oxic)}=11±3.0×10⁻² min⁻¹), suggesting an important role of dissolved O₂ in the PDS Light system with ATZ. The appreciable removal of ATZ under anoxic condition was attributed to the degradation of ATZ by SO₄^{●-} as the main reactive species, and the higher rate constant under oxic condition suggested the formation of additional reactive species. The very similar effects of scavengers on the degradation of ATZ in both oxic and anoxic conditions, except for the much minor inhibitory effect of SOD under anoxic condition, further supports the role of O2 in the PDS light system with ATZ. To solidify the results, the impacts of scavengers themselves on the decay of PDS under light were examined under both oxic and anoxic conditions (FIG. 9). No impact was observed for MeOH, TBA, and SOD on the decay of PDS. However, accelerated decay of PDS in the presence of L-his was noticed, suggesting that PDS can be directly consumed by L-his. Therefore, the hindered degradation of ATZ by PDS in the presence of L-his could be attributed to lower PDS concentration and/or simultaneous quenching of SO₄^{●-}, ^{●}OH and ¹O₂. Overall, the quenching experiments inferred substantial roles of SO₄^{●-} and O₂^{●-}.

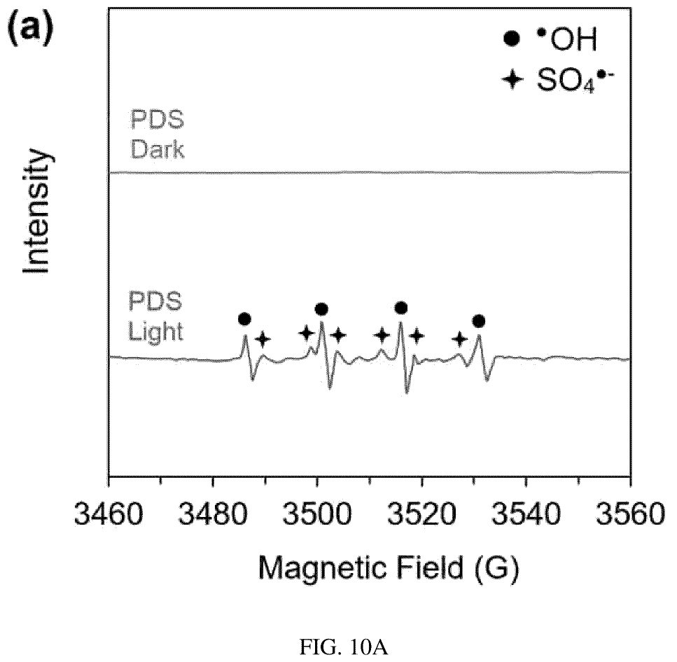

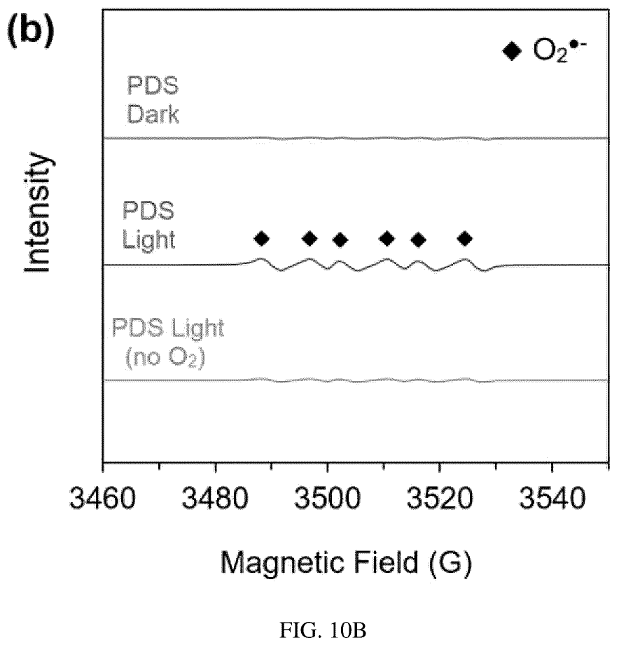

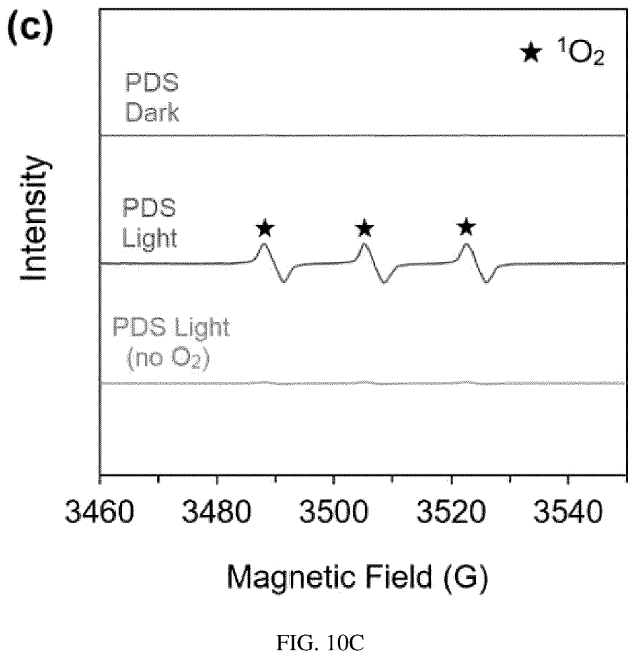

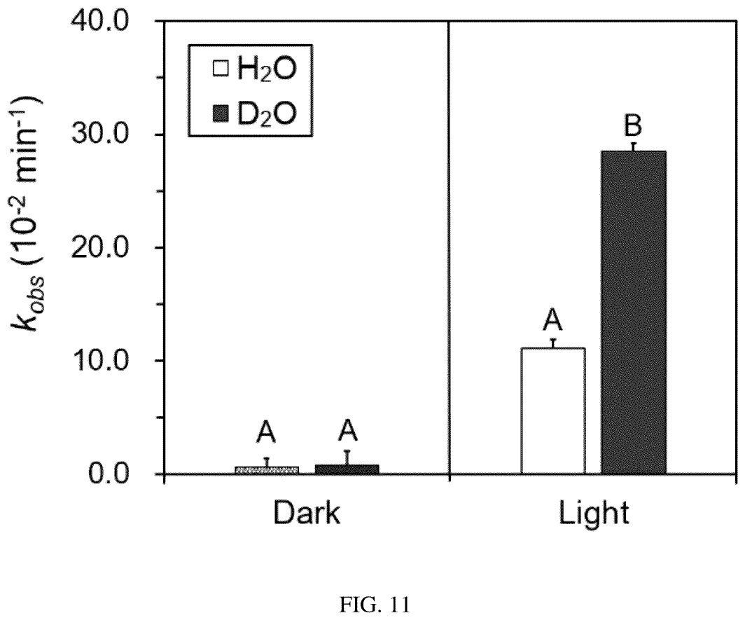

EPR spectroscopy was used to detect the four reactive species in the PDS system with ATZ. It is clear that signals of both DMPO-SO₄^{●-} and DMPO-OH^{●} adducts were observed in PDS Light with ATZ (FIG. 10A). In addition to the reaction between ^{●}OH and DMPO, DMPO-OH^{●} adduct can also be formed via a nucleophilic substitution between DMPO-SO₄^{●-} and hydroxide ion (OH⁻). The fast transformation from DMPO-SO4^{●-} to DMPO-OH^{●} is the reason why DMPO-SO₄^{●-} is rarely detected alone. The quenching analysis and EPR measurements together strongly suggest the dominant role of SO₄^{●-} in the degradation of ATZ in the PDS Light system. Consistent with the quenching analysis, clear signals of DMPO-O₂^{●-} and TEMPO were observed under oxic condition, but both of them disappeared under anoxic condition (FIG. 10B and 10C), indicating that the production of O₂^{●-} and ¹O₂ in PDS Light strongly relied on O₂. In order to further confirm the role of ¹O₂, the degradation of ATZ was repeated with D₂O as the solvent. The pseudo-first-order rate constant for ATZ degradation by PDS Light in D2O was more than 2.5 times higher than that in water, whereas the effect of D₂O was negligible for PDS Dark (FIG. 11). Together, the instant example provides evidence for the participation of ¹O₂ in the degradation of ATZ by PDS Light, and dissolved O₂ is a critical factor in the formation of ¹O₂. The non-detection of EPR signals in PDS Dark (FIGS. 10A-10C), further confirms the direct oxidation of ATZ by PDS in dark (FIG. 4).

### EXAMPLE 5

### Quantification of Hydrogen Peroxide and Identification of Degradation Metabolites

The presence of H₂O₂ in PDS Dark and PDS Light was determined with a previously reported spectrophotometric method based on the reaction between H₂O₂ and metavanadate under acidic medium to produce peroxovanadate with a main absorption peak at around 450 nm using a UV-Vis-NIR spectrophotometer (Hitachi U-4100).

Further, to identify the degradation pathways of ATZ by PDS, samples were collected at 120 min and 10 min for PDS Dark and PDS Light, respectively, followed by solid-phase-extraction (SPE) to extract remaining ATZ and degradation metabolites. The procedures for SPE are summarized in Example 1. Untargeted liquid chromatography high resolution accurate mass spectrometry (LC-HRAM) analysis was performed on a Q Exactive Plus orbitrap mass spectrometer (Thermo Fisher Scientific, Waltham, USA) coupled to a binary pump UltiMate 3000 HPLC to detect the degradation metabolites of ATZ.

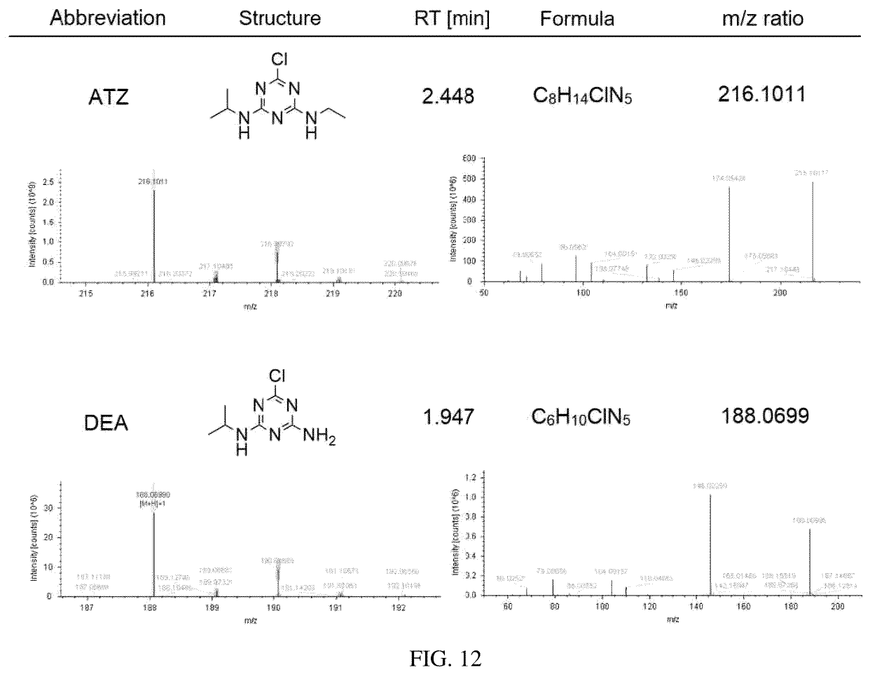

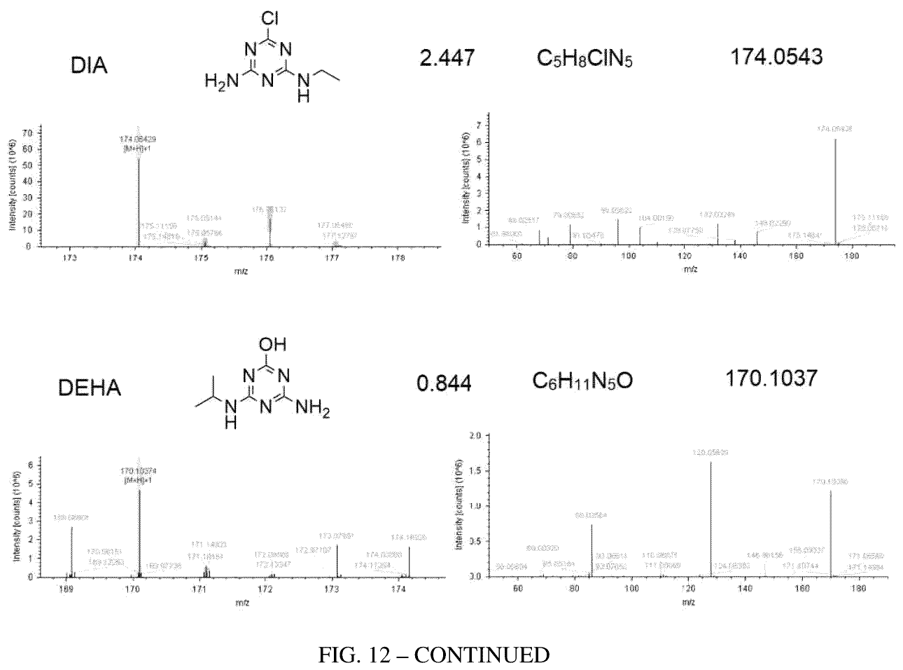

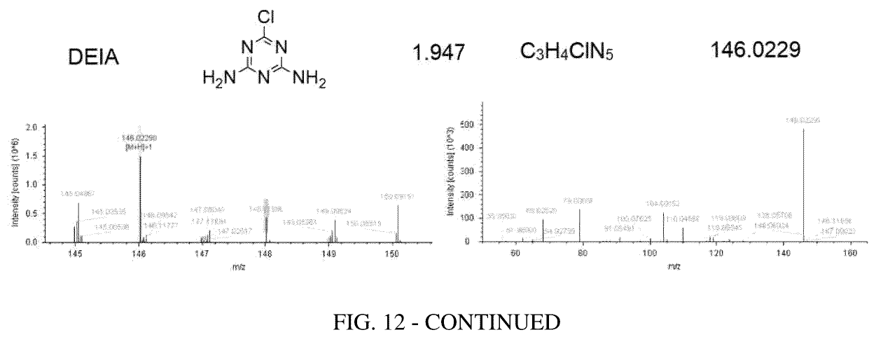

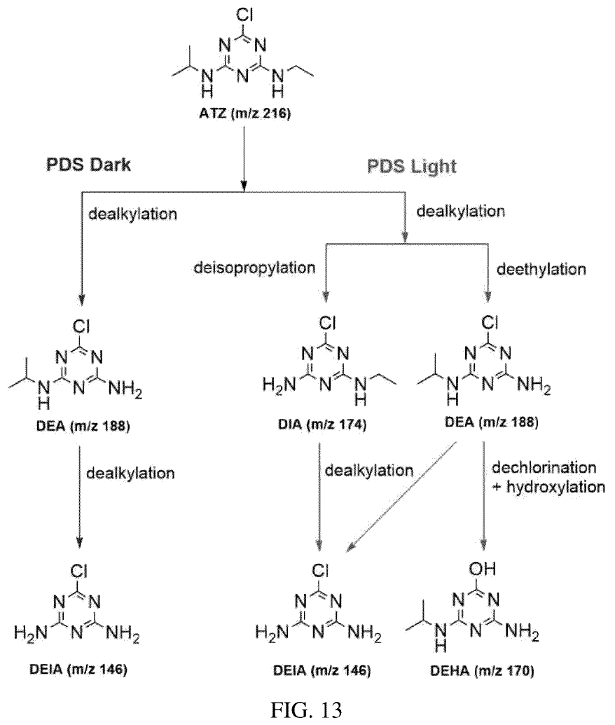

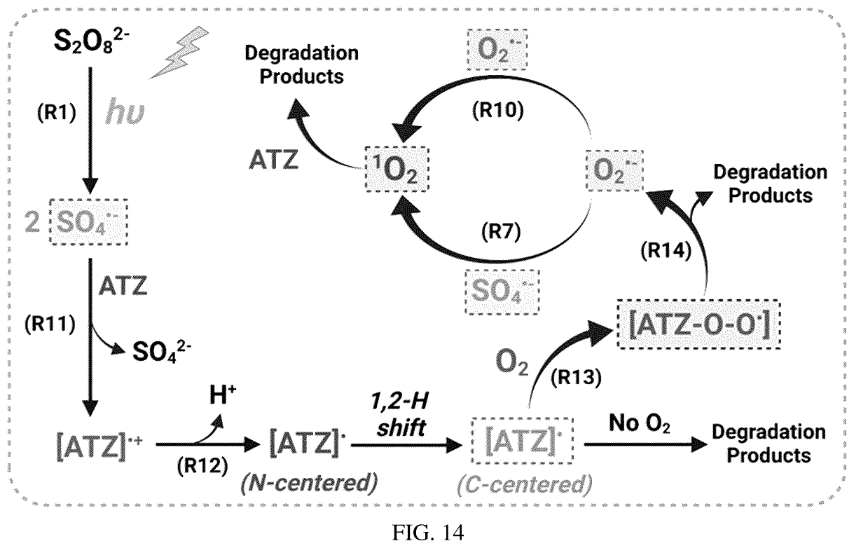

To further understand the mechanisms of ATZ breakdown in the PDS Light system, the degradation intermediates of ATZ by PDS in dark and under light in oxic condition were identified (Table 2, FIG. 12), and possible degradation pathways were illustrated (FIG. 13).

TABLE 2
Light Information about the identified degradation intermediates
of ATZ by PDS in dark and under light.

| | | Molecular | m/z |
|---|---|---|---|
| Full Name | Abbreviation | formula | ratio |
| 2-chloro-4-ethylamino-6- | ATZ | C₈H₁₄C1N₅ | 216 |
| isopropylamino-s-triazine | | | |
| 2-chloro-4-amino-6-isopropylamino- | DEA | C₆H₁₀C1N₅ | 188 |
| 1,3,5-triazine | | | |
| 2-chloro-4-ethylamino-6-amino- | DIA | C₅H₈C1N₅ | 174 |
| 1,3,5-triazine | | | |
| 2-hydroxyl-4-amino-6- | DEHA | C₆H₁₁N₅O | 170 |
| (isopropylamino)-1,3,5-triazine | | | |
| 2-chloro-4,6-diamino-1,3,5-triazine | DEIA | C₃H₄C1N₅ | 146 |

It has been suggested that electron transfer is the primary reaction pathway between SO₄^{●-} and electron-rich aromatic compounds, and in the case of ATZ, de-alkylation of the N-ethyl group on the side chain is widely accepted as the prevalent degradation pathway Based on this, a reaction mechanism between SO₄^{●-} and ATZ has been proposed, which reasonably justified the dominance of de-ethylation, accompanied by the release of O₂^{●-} (R11-R14).

SO₄^{●-}+ATZ→[ATZ]^{●+}+SO₄²⁻ (R11)

[ATZ]^{●+}→[ATZ]^{●}+H⁺ (R12)

[ATZ]^{●}+O₂→[ATZ-O—O^{●}] k₁₃=3.0×10⁹ M⁻¹·s⁻¹ (R13)

[ATZ-O—O^{●}]→O₂^{●-}/HO₂^{●}+products (R14)

The initial step involves the one-electron oxidation of ATZ by SO₄^{●-} to yield an ATZ radical cation ([ATZ]^{●+}) (R11). After losing a proton either from the ethyl N-atom or the isopropyl N-atom on the side chain, the [ATZ]^{●+} is expected to transform to two N-centered radical forms ([ATZ]^{●}) that are at equilibrium with each other (R12). The unpaired electron either sits on the N-atom of the N-ethyl or the N-isopropyl group. Under the catalysis of water molecule, a 1,2-H shift can occur on the N-centered radicals, similarly to the 1,2-H shift of alkoxyl radicals, to produce C-centered radicals, with the unpaired electron shifting onto the nearest aliphatic C-atoms followed by the addition of a H-atom to the N-atom. Following that, the C-centered radicals can readily react with O2 to form peroxyl adduct (k=3×10⁹ M⁻¹·s⁻¹) (R13) and then release O₂^{●+} or hydroperoxyl radical (HO₂^{●}) (R14). Consequently, a double bond can be formed between the N- and C- atom, which can be broken via hydrolysis to produce 2-chloro-4-amino-6-isopropylamino-1,3,5-triazine (DEA) or 2-chloro-4-ethylamino-6-amino-1,3,5-triazine (DIA) (Table 2). The H-atom on the N-ethyl group is more likely to deprotonate due to the higher acidity of the H-atom on the N-ethyl group than that on the N-isopropyl

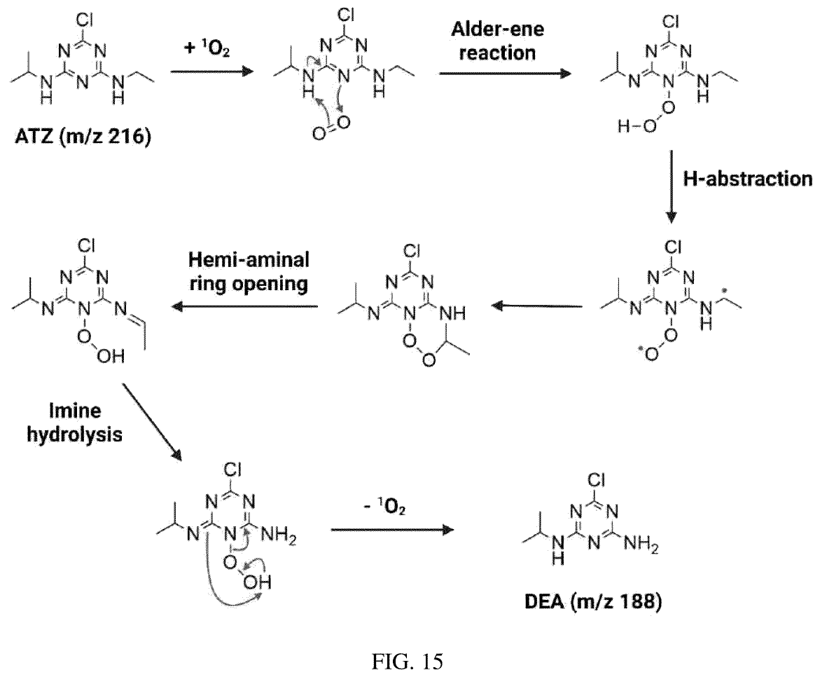

group, which favors the formation of C-centered radicals and subsequent reactions. Therefore, formation of DEA might be more favorable than DIA. According to the oxidized products, the signal intensities of DEA and DIA were almost 10 times higher than the other products (FIG. 12), consistent with the mechanisms. In addition to SO₄^{●-}, DEA and DIA can also be produced via the reaction between ¹O₂ and ATZ. An Alder-ene reaction could be initiated by ¹O₂, followed by hydrogen-abstraction, hemi-aminal ring opening, and imine hydrolysis, to degrade ATZ to DEA (FIG. 15). Similar pathway could also occur on the other side chain to form DIA.

Overall, the aforementioned reaction mechanisms agree well with the results of the quenching experiments and EPR spectra. When ATZ is present, the SO₄^{●-} produced by PDS Light reacts rapidly with ATZ and might be the most dominant reactive species that contributes to the degradation of ATZ. The formation of ^{●}OH is expected to be limited. Generation of [ATZ]^{●+}as a result of ATZ oxidation by SO₄^{●-} led to the production of O₂^{●-}in the presence of O₂ (R11-R14). The slightly enhanced decay of PDS with the presence of ATZ under light (FIG. 3B) may also be attributed to this mechanism. Overall, SO₄^{●-} was the dominant reactive species for ATZ degradation under anoxic condition, whereas both SO₄^{●-} and ¹O₂ contributed to ATZ degradation under oxic condition.

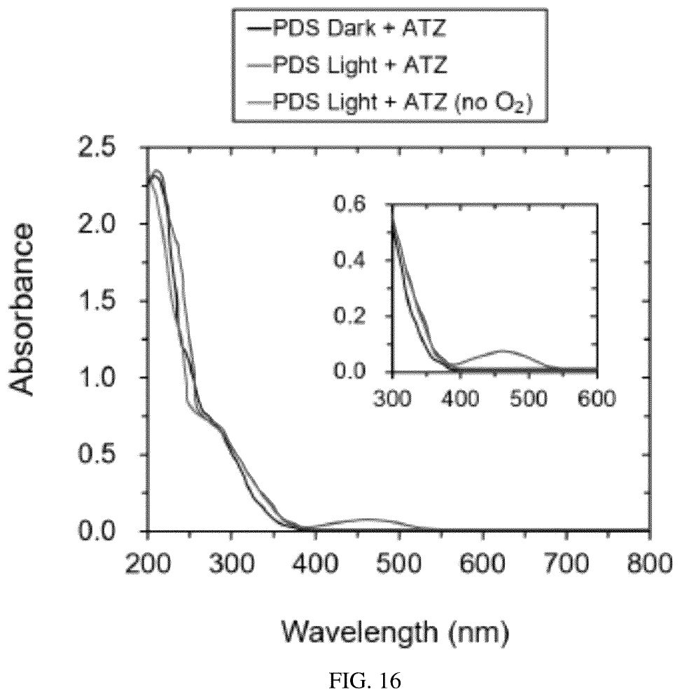

To verify the mechanisms discussed above, presence of H₂O₂ in PDS Light under oxic and anoxic condition was determined (FIG. 16). Under oxic condition, slight absorption at ˜453 nm suggested that only a small amount of H₂O₂ was produced, possibly as a byproduct of R10a-b in addition to ¹O₂. Moreover, the negligible absorption between 400 and 500 nm under anoxic condition is expected, because formation of H₂O₂ in presence of ATZ is very unlikely when R2 and R13 are hindered.

To gain more understanding on the PDS utilization efficiency under visible light, corresponding RSE was calculated. Overall, the average RSE for PDS Light was less than 1.0%, which was lower than expected. This could be ascribed to the relatively high initial concentration of PDS (5 mM) and low initial concentration of ATZ (10 uM), which are unfavorable for a high RSE. Scavenging of SO₄^{●-} by co-present inorganic anions (e.g. phosphate) could be another reason of low RSE.

What is claimed is:

1. A method of treating a compound with a reactive oxygen species, the method comprising:
a) contacting peroxydisulfate with a source of visible light to generate the reactive oxygen species, and b) treating the compound with the reactive oxygen species generated from peroxydisulfate.

2. The method of claim 1, wherein the treating comprises one or more of inactivation, disinfecting, or degrading the compound.

3. The method of claim 1, wherein the reactive oxygen species is selected from the group consisting of SO₄^{●-}, SO₃^{●-}, S₂O₅^{●}, ^{●}OH, O₂^{●-}, ¹O₂, H₂O₂, and any combination thereof.

4. The method of claim 1, wherein the reactive oxygen species comprises SO₄^{●-}.

5. The method of claim 1, wherein the reactive oxygen species comprises SO₃^{●-}.

6. The method of claim 1, wherein the reactive oxygen species comprises S₂O₅^{●}.

7. The method of claim 1, wherein the reactive oxygen species comprises ^{●}OH.

8. The method of claim 1, wherein the reactive oxygen species comprises O₂^{●-}.

9. The method of claim 1, wherein the reactive oxygen species comprises ¹O₂.

10. The method of claim 1, wherein the reactive oxygen species comprises H₂O₂.

11. The method of claim 1, wherein the source of visible light comprises sunlight.

12. The method of claim 1, wherein the compound is in a liquid.

13. The method of claim 12, wherein the liquid is water.

14. The method of claim 1, wherein the compound is a pesticide.

15. The method of claim 1, wherein the compound is a herbicide.

16. The method of claim 1, wherein the compound is a pharmaceutical.

17. The method of claim 1, wherein the compound is a microorganism.

18. The method of claim 1, wherein the method is performed substantially free of a catalyst.

19. The method of claim 1, wherein the method does not comprise an 5 additional activator compound.

20. The method of claim 1, wherein the method does not comprise an additional energy input.
